(19) United States
(12) Patent Application Publication
(10) Pub. No.: US 2025/0106165 A1
(43) Pub. Date: Mar. 27, 2025

(54) METHOD AND APPARATUS FOR PROCESSING MULTIPLEXED DATA IN A WIRELESS COMMUNICATION SYSTEM

(71) Applicant: Samsung Electronics Co., Ltd., Gyeonggi-do (KR)

(72) Inventors: Jaehyeon BAE, Gyeonggi-do (KR); Youngkyo BAEK, Gyeonggi-do (KR); Jicheol LEE, Gyeonggi-do (KR)

(21) Appl. No.: 18/896,168

(22) Filed: Sep. 25, 2024

(30) Foreign Application Priority Data
Sep. 27, 2023 (KR) 10-2023-0130793
Aug. 14, 2024 (KR) 10-2024-0109152

(51) Int. Cl. H04L 47/2416; H04L 47/12

(52) U.S. Cl. CPC H04L 47/2416; H04L 47/12

(57) ABSTRACT

The disclosure relates to a 5G or 6G communication system for supporting higher data rates. According to the disclosure, a method performed by a policy control function (PCF) that supports radio access network (RAN) scheduling based on a protocol data unit (PDU) set includes receiving, from an application function (AF) entity, an AF session with a required quality of service (QOS), the AF session with the required QoS including QOS requirements for media flows and an additional packet filter, determining, based on the additional packet filter, at least one primary component carrier (PCC) rule for the media flows, and transmitting, to a session management function (SMF) entity, the at least one PCC rule.

### CROSS REFERENCE TO RELATED APPLICATION(S)

The present application claims priority under 35 U.S.C. § 119 to Korean Patent Application Nos. 10-2023-0130793 and 10-2024-0109152, which were filed in the Korean Intellectual Property Office on Sep. 27, 2023, and Aug. 14, 2024, respectively, the entire content of each of which is incorporated herein by reference.

### BACKGROUND

### 1. Field

The disclosure relates generally to a terminal and a base station (BS) in a communication system, and more particularly, to a method and device for supporting scheduling of a radio access network (RAN) through creation and allocation of classification information considering packet characteristics for media types in the communication system.

### 2. Description of Related Art

Fifth generation (5G) mobile communication technology defines a wide frequency band to enable a fast transmission speed and new services, and may be implemented not only in a sub 6 gigahertz (GHz) frequency band but also in an ultra-high above 6 GHz frequency band referred to as a millimeter wave (mmWave) band, such as 28 GHz and 39 GHz. In the sixth generation (6G) mobile communication technology, which is referred to as a beyond 5G system, to achieve a transmission speed that is 50 times faster than that of 5G mobile communication technology and ultra-low latency reduced to 1/10 compared to that of 5G mobile communication technology, implementations in terahertz (THz) bands such as a 95 GHz to 3 THz band, are being considered.

Since the inception of 5G mobile communication technology, to satisfy the service support and performance requirements for an enhanced mobile broadband (eMBB), ultra-reliable low-latency communications (URLLC), and massive machine-type communications (mMTC), standardization has been performed for beamforming and massive multi-input multi-output (MIMO) for mitigating a path loss of radio waves in an ultra-high frequency band and increasing a propagation distance of radio waves, support for various numerologies (multiple subcarrier spacing operation, etc.) for efficient use of ultra-high frequency resources and dynamic operation for slot formats, initial access technology for supporting multi-beam transmission and broadband, a definition and operation of a band-width part (BWP), a new channel coding method such as low density parity check (LDPC) code for large capacity data transmission and polar code for high reliable transmission of control information, layer 2 (L2) pre-processing, and network slicing that provides a dedicated network specialized for specific services.

Currently, discussions are ongoing to improve initial 5G mobile communication technology and enhance a performance thereof in consideration of services in which 5G mobile communication technology was intended to support, and physical layer standardization for technologies such as vehicle-to-everything (V2X) for helping driving determination of an autonomous vehicle and increasing user convenience based on a location and status information of the vehicle transmitted by the vehicle, new radio unlicensed (NR-U) for the purpose of a system operation that meets various regulatory requirements in unlicensed bands, NR user equipment (UE) power saving, a non-terrestrial network (NTN), which is direct UE-satellite communication for securing coverage in regions where communication with a terrestrial network is impossible, and positioning is in progress.

Standardization in the field of air interface architecture/protocol for technologies such as industrial Internet of things (IIOT) for supporting new services through linkage and convergence with other industries, integrated access and backhaul (IAB) that provides nodes for expanding network service regions by integrating wireless backhaul links and access links, mobility enhancement including conditional handover and dual active protocol stack (DAPS) handover, and 2-step random access channel (RACH) for NR that simplifies a random access procedure is also in progress, and standardization in the system architecture/service field for 5G baseline architecture (e.g., service based architecture, service based interface) for applying network functions virtualization (NFV) and software-defined networking (SDN) technologies, mobile edge computing (MEC) that receives services based on a location of a UE, and the like is also in progress.

When such a 5G mobile communication system is commercialized, connected devices in an explosive increase trend will be connected to communication networks; thus, it is expected that function and performance enhancement of a 5G mobile communication system and integrated operation of connected devices will be required. To this end, new research on extended reality (XR) for efficiently supporting augmented reality (AR), virtual reality (VR), mixed reality (MR), etc., 5G performance improvement and complexity reduction using artificial intelligence (AI) and machine learning (ML), AI service support, metaverse service support, and drone communication will be conducted.

The development of such a 5G mobile communication system will be the basis for the development of full duplex technology for improving frequency efficiency and system network of 6G mobile communication technology, satellite, AI-based communication technology that utilizes AI from a design stage and that realizes system optimization by internalizing end-to-end AI support functions, and next generation distributed computing technology that realizes complex services beyond the limits of UE computing capabilities by utilizing ultra-high-performance communication and computing resources as well as a new waveform for ensuring coverage in a THz band of 6G mobile communication technology, full dimensional MIMO (FD-MIMO), multi-antenna transmission technologies such as an array antenna and large scale antenna, metamaterial-based lenses and antennas for improving coverage of terahertz band signals, high-dimensional spatial multiplexing technology using orbital angular momentum (OAM), and reconfigurable intelligent surface (RIS) technology.

The third generation partnership project (3GPP), which controls cellular mobile communication standards, is standardizing a new core network (CN) structure referred to as the 5G core (5GC), to evolve from a fourth generation (4G) long term evolution (LTE) system to a 5G system. The 5GC supports differentiated functions compared to an evolved packet core (EPC), which is a network core for 4G.

In 5GC, a network slice function is introduced. The 5GC should be able to support various UE types and services to meet requirements of 5G, such as the eMBB, URLLC, and mMTC. Each UE or service may have different requirements for a CN according to what service it supports. For example, an eMBB service may require a high data rate. An URLLC service may require high stability and low delay. As a result, network slice technology is disclosed to meet requirements of 5G according to support of various services.

Specifically, network slicing refers to a method of virtualizing a single physical network to activate multiple logical networks (e.g., network slices). Each network slice activated through network slicing may be referred to as a network slice instance (NSI). Each NSI may have different characteristics. Mobile communication service providers may constitute a network function (NF) for each NSI that matches characteristics of the NSI to satisfy various service requirements according to the UE or service. For example, a mobile communication service provider may efficiently support various 5G services (e.g., eMBB, URLLC, or mMTC) by allocating to each UE an NSI that matches characteristics of a service required by each UE.

The 5GC may support a network virtualization paradigm through separation of a mobility management function and a session management function (SMF). All UEs in 4G LTE may receive services from the network through signaling exchange with a single core entity called a mobility management entity (MME), which is responsible for registration, authentication, mobility management, and SMFs. However, in 5G, the number of UEs performing machine type communications (MTC) has exponentially increased, and the mobility and traffic or session characteristics that should be supported may be segmented according to a type of the UE. Accordingly, when all functions are supported by a single entity (e.g., MME), scalability of adding entities for each required function is inevitably reduced. Accordingly, there is a need in the art for functions developed based on a structure that separates the mobility management function and the SMF to improve scalability in terms of the function or implementation complexity of the core entity responsible for the control plane (CP) and signaling load.

In the case of metaverse and XR applications, the UE should transmit a large amount of traffic through a downlink (DL) or an uplink (UL). Therefore, effectively handling traffic is an important technical problem that should be solved unlike existing applications.

Existing studies have focused on effectively transmitting DL traffic to UEs. In contrast, in the case of metaverse/XR applications, there is a need in the art for a new task to effectively process DL traffic considering service characteristics for each packet.

As such, there is a need in the art for a device and method that can effectively create and allocate classification information in consideration of characteristics of packets for each media type when packets of different media types are multiplexed and transmitted through a single service flow.

### SUMMARY

The disclosure has been made to address at least the above-mentioned problems and/or disadvantages and to provide at least the advantages described below.

Accordingly, an aspect of the disclosure is to provide a method and apparatus to cure a congestion situation when the congestion situation occurs in a process of processing traffic in a network entity.

An aspect of the disclosure is to provide a method of processing a packet in a user plane function (UPF).

An aspect of the disclosure is to provide a device and method for creating information for processing packets with the same characteristics in consideration of service traffic characteristics in a communication system.

In accordance with an aspect of the disclosure, a method of processing a control signal of a wireless communication system includes receiving a first control signal transmitted from a BS, processing the received first control signal, and transmitting a second control signal created based on the processing to the BS.

In an embodiment, a method performed by a policy control function (PCF) entity in a communication system, the method comprising: receiving, from an application function (AF) entity, an AF session with a required quality of service (QOS), the AF session with the required QoS including QoS requirements for media flows and an additional packet filter; based on the additional packet filter, determining at least one primary component carrier (PCC) rule for the media flows; and transmitting, to a session management function (SMF) entity, the at least one PCC rule.

In an embodiment, a method performed by a session management function (SMF) entity in a communication system, the method comprising: receiving, from a policy control function (PCF) entity, at least one primary component carrier (PCC) rule for media flows; and transmitting, to a user plane function (UPF) entity, quality of service (QOS) flows and an additional packet filter via an N4 message, wherein the at least one PCC rule is determined based on the additional packet filter.

In an embodiment, a policy control function (PCF) entity in a communication system, the PCF entity comprising: a transceiver; and a controller coupled with the transceiver, the controller configured to: receive, from an application function (AF) entity, an AF session with a required quality of service (QOS), the AF session with the required QoS including QOS requirements for media flows and an additional packet filter, based on the additional packet filter, determine at least one primary component carrier (PCC) rule for the media flows, and transmit, to a session management function (SMF) entity, the at least one PCC rule.

In an embodiment, a session management function (SMF) entity in a communication system, the SMF entity comprising: a transceiver; and a controller coupled with the transceiver, the controller configured to: receive, from a policy control function (PCF) entity, at least one primary component carrier (PCC) rule for media flows, and transmit, to a user plane function (UPF) entity, quality of service (QOS) flows and an additional packet filter via an N4 message, wherein the at least one PCC rule is determined based on the additional packet filter.

### BRIEF DESCRIPTION OF THE DRAWINGS

The above and other aspects, features, and advantages of certain embodiments of the disclosure will be more apparent from the following detailed description taken in conjunction with the accompanying drawings, in which:

FIG. 1 illustrates a network structure and interface of a 5G system according to an embodiment;

FIG. 2 illustrates an operation for classifying packets into grouping units in a wireless communication system according to an embodiment;

FIG. 3A illustrates a method of performing RAN scheduling in a wireless communication system according to an embodiment;

FIG. 3B illustrates a method of performing RAN scheduling in a wireless communication system according to an embodiment;

FIG. 3C illustrates a method of performing RAN scheduling in a wireless communication system according to an embodiment;

FIG. 3D illustrates a method of performing RAN scheduling in a wireless communication system according to an embodiment;

FIG. 3E illustrates a method of performing RAN scheduling in a wireless communication system according to an embodiment;

FIG. 3F illustrates a method of performing RAN scheduling in a wireless communication system according to an embodiment;

FIG. 4 illustrates an operation for performing RAN scheduling in a wireless communication system according to an embodiment;

FIG. 5A illustrates a method of performing a RAN scheduling operation in a wireless communication system according to an embodiment;

FIG. 5B illustrates a method of performing a RAN scheduling operation in a wireless communication system according to an embodiment;

FIG. 5C illustrates a method of performing a RAN scheduling operation in a wireless communication system according to an embodiment; and

FIG. 6 illustrates a structure of a network entity according to an embodiment.

### DETAILED DESCRIPTION

Hereinafter, embodiments of the disclosure will be described in detail with reference to the accompanying drawings. It should be noted that in the drawings, the same or similar elements are preferably denoted by the same or similar reference numerals. Detailed descriptions of known functions or configurations that may make the subject matter of the disclosure unclear will be omitted for the sake of clarity and conciseness.

Terms described below are terms defined in consideration of functions in the disclosure, which may vary according to intentions or customs of users and providers. Therefore, the definition should be made based on the content throughout this specification.

Some components are exaggerated, omitted, or schematically illustrated in the accompanying drawings. The size of each component does not fully reflect the actual size. In each drawing, the same reference numerals are given to the same or corresponding components.

The disclosure is not limited to the embodiments disclosed below, but may be implemented in various different forms. Embodiments of the disclosure are provided to fully inform the scope of the disclosure to those of ordinary skill in the art to which the disclosure pertains. Like reference numerals may refer to like components throughout the specification.

Hereinafter, a BS is a subject performing resource allocation of a terminal, and may be at least one of a gNode B, an eNode B, a node B, (or xNode B (where x is an alphabet including g, e)), a radio access unit, a BS controller, a satellite, an airborne, or a node on a network. A UE may include a mobile station (MS), a vehicle, a satellite, an airborne, a cellular phone, a smart phone, a computer, or a multimedia system capable of performing a communication function. In the disclosure, a DL is a wireless transmission path of a signal transmitted from a BS to a UE, and a UL is a wireless transmission path of a signal transmitted from a UE to a BS. Additionally, a sidelink (SL), which refers to a wireless transmission path of a signal transmitted from a UE to another UE, may exist.

Hereinafter, a term identifying an access node and indicating network entities or network functions, messages, an interface between network objects, and various identification information are described for convenience of description. Accordingly, the disclosure is not limited to the terms described below, and other terms indicating an object having an equivalent technical meaning may be used.

Although the LTE, LTE-advanced (LTE-A) or 5G system may be described below as an example, embodiments of the disclosure may also be applied to other communication systems with similar technical background or channel type. For example, embodiments of the disclosure may include 5G-Advanced, NR-Advanced, or 6G, and 5G may include existing LTE, LTE-A, and other similar services. The disclosure may be applied to other communication systems through some modifications without significantly departing from the scope of the disclosure at the discretion of a person with skilled technical knowledge.

In this case, it will be understood that each block of message flow diagrams and combinations of the message flow diagrams may be performed by computer program instructions. Because these computer program instructions may be mounted in a processor of a general purpose computer, special purpose computer, or other programmable data processing equipment, the instructions performed by a processor of a computer or other programmable data processing equipment generate a means that performs functions described in the message flow diagram block(s). Because these computer program instructions may be stored in a computer usable or computer readable memory that may direct a computer or other programmable data processing equipment in order to implement a function in a particular manner, the instructions stored in the computer usable or computer readable memory may produce a production article containing instruction means for performing the function described in the message flow diagram block(s). Because the computer program instructions may be mounted on a computer or other programmable data processing equipment, a series of operation steps are performed on the computer or other programmable data processing equipment to generate a computer-executed process; thus, instructions for performing the computer or other programmable data processing equipment may provide steps for performing functions described in the message flow diagram block(s).

Further, each block may represent a portion of a module, a segment, or a code including one or more executable instructions for executing a specified logical function(s). Further, it should be noted that in some alternative implementations, functions recited in the blocks may occur out of order. For example, two blocks illustrated one after another may in fact be performed substantially simultaneously, or the blocks may be sometimes performed in the reverse order according to the corresponding function.

In this case, the term ‘−unit’ used in this embodiment means software or hardware components such as field programmable gate array (FPGA) or application specific integrated circuit (ASIC), and ‘−unit’ performs certain roles. However, ‘−unit’ is not limited to software or hardware. ‘−unit’ may be constituted to reside in an addressable storage medium or may be constituted to reproduce one or more processors. Therefore, as an example, ‘−unit’ includes components such as software components, object-oriented software components, class components, and task components, processes, functions, properties, procedures, subroutines, segments of program code, drivers, firmware, microcode, circuit, data, databases, data structures, tables, arrays, and variables. Functions provided in the components and ‘−units’ may be combined into a smaller number of components and ‘−units’ or may be further separated into additional components and ‘−units’. Further, components and ‘−units’ may be implemented to reproduce one or more CPUs in a device or secure multimedia card. Further, in embodiments, ‘−unit’ may include one or more processors.

Components included in the disclosure may be expressed in the singular or plural according to the disclosed embodiments. However, the singular or plural expression is appropriately selected for a situation presented for convenience of description, and the disclosure is not limited to the singular or plural components. Even if a component is represented in the plural, it may be singularly formed, or vice-versa.

3GPP, which is in charge of cellular mobile communication standards, is standardizing a new core network structure, named 5G core (5GC), in order to evolve from a 4G LTE system to a 5G system. The 5GC supports the following differentiated functions compared to an evolved packet core (EPC), which is a network core for 4G.

Hereinafter, for convenience of description, some terms and names defined in the 3rd generation partnership project long term evolution (3GPP) standard may be used. However, the disclosure is not limited by the above terms and names and may be equally applied to systems complying with other standards.

In the following description, in describing the disclosure, in the case that it is determined that a detailed description of a related well-known function or constitution may unnecessarily obscure the gist of the disclosure, a detailed description thereof will be omitted. Hereinafter, embodiments of the disclosure will be described with reference to the attached drawings.

In the case of metaverse and extended reality (XR) applications, the UE should transmit a large amount of traffic through a downlink or an uplink. Therefore, effectively handling traffic may be an important technical problem that should be solved unlike existing applications.

Existing studies have focused on effectively transmitting downlink traffic to UEs. In contrast, in the case of metaverse/XR applications, a new task is to effectively process downlink traffic considering service characteristics for each packet.

As will be described herein, compared to the conventional art in which packets are randomly dropped in a scheduler, an XR service of the disclosure may use traffic characteristic information currently provided in the service may be used through an application function (AF) entity or an application server (AS). Specifically, when packets are dropped, packets with the same characteristics may be processed in a protocol data unit (PDU) set. In this case, the importance of serviced packets may be considered. As a result, when a congestion situation occurs in the network, the congestion situation can be efficiently addressed.

As will be described herein, compared to the conventional art in which data is forwarded using a simple 5-tuple, the disclosure provides a method of grouping packets with the same characteristics using service characteristics. The UPF may recognize and extract real-time transport protocol (RTP) and network adaptation layer (NAL) unit header information of actual data. The UPF may perform a process of grouping (PDU set) packets with the same characteristics for each unit based on the recognized and extracted information. The UPF may create PDU set information based on the recognized and extracted information or information received from an AS. The UPF may provide the created PDU set information to the RAN through a GPRS tunneling protocol (GTP)-U header. Thereafter, the disclosed RAN provides a method of scheduling radio resources to the UE based on the provided PDU set information.

As will be described in detail below, packets with different media characteristics may be transmitted through one service flow in a communication system. In this case, the UPF may transmit information (e.g., PDU set information) for processing packets with the same characteristics for each packet to the RAN in consideration of service traffic characteristics. When packets with different media characteristics are transmitted to the RAN within one service flow, the UPF may notify the fact that packets with different media characteristics are transmitted to the RAN of the policy control function (PCF). In this case, when the UPF detects packets in one service flow, the UPF may request to create a primary component carrier (PCC) rule including a quality of service (QOS) flow identifier (QFI) allocation information for each media type to allocate the corresponding packets with different QoS flows. The PCC rule creation request may be transmitted to the SMF. The SMF that has received the corresponding PCC rule may transmit separate QoS enforcement rule (QER) information within the same packet detection rule (PDR) to the UPF. When QFI allocation for each media type is performed, the SMF may map packets transmitted with a single service flow to a separate QoS flow and transmit information related to scheduling performance in the RAN based on related QoS information and QFI allocation for each media characteristic.

As will be described in detail below, when packets with different media characteristics are transmitted through one service flow in a wireless communication system, a differentiated services codepoint (DSCP) marking operation for distinguishing packets within a single QoS flow may be performed considering media characteristics. The AF may transmit relevant information, to the PCF through the protocol description, that packets within the service flow are multiplexed service flows with different media types and which media types (e.g., video and audio) are being transmitted in the service flow. In this case, the service provider may transmit together service support indicator information for distinguishing information on media packets within the same QoS flow to the PCF. The PCF that has received the information may perform a PCC rule update or creation operation for distinguishing media packets within the same QoS flow through DSCP marking. The SMF that has received a PCC rule including request indicator information related to DSCP marking from the PCF may determine a DSCP value based on 5QI and ARP information to be used for DSCP marking. The SMF may include DSCP marking related information in the FAR and transmit DSCP marking related information to the UPF for a request operation of the corresponding DSCP marking. The UPF may detect the traffic, mark DSCP information in an IP header of packets for each media type and transmit the marked DSCP information to the RAN. The RAN may receive QFI mapping information linked to the DSCP value from the SMF. Based on the above information, the RAN may map QoS information of appropriate packets based on the DSCP marking information and utilize relevant information during RAN scheduling.

As will be described in detail below, a method performed by a PCF entity in a wireless communication system includes receiving a QoS session related message from an AF, and transmitting PCC rule information to the SMF.

The PCF entity may support RAN scheduling based on a PDU set, which is a unit of packets classified as traffic characteristics among download packets.

The QoS session related message may include at least one of a protocol description message or an indicator requesting an operation of distinguishing packets in the multiplexed service flow in the RAN based on media characteristic information.

The protocol description message may include at least one of RTP payload type information such as a codec type and a sampling rate, an indicator indicating whether packets in the service flow include PDU set information within the RTP header extension (PDU set information supported for all packet within service flow), or information indicating that multiplexed packets with different media characteristics are transmitted within a single service flow.

PCC rule information may include at least one of allocated QoS profile information based on media characteristics in the multiplexed service flow or a PDR for processing packets with different media characteristics.

As will be described in detail below, the AF may provide a protocol description including characteristic information of one or more media constituting the corresponding service flow in order for the RAN to request PDU set-based scheduling support in consideration of characteristics of the service when providing a service consisting of one or more media. When there is indicator information that multiple media types in the service flow are multiplexed based on a protocol description including characteristic information of media, the PCF may determine a policy update considering the information. Within the corresponding PCC rule, the UPF may include indicator information for processing packets of different media types within one service flow, information for creation of PDU set information or recognizing PDU set information transmitted within the packet header, and a protocol description including media payload type information for distinguishing packets. Thereafter, the PCF may provide the corresponding created or updated PCC rule including indicator information for sub QoS flow allocation to the SMF to request to create and transmit information for requesting to perform the corresponding sub QoS flow allocation operation to the UPF. The sub QoS flow allocation operation may include a sub QoS flow creation request operation that maps packets for each media type within one service data flow (SDF) transmitted to the UPF to each QoS flow. The sub QoS flow allocation operation may include an operation of marking information for distinguishing packets within the same QoS flow through a DSCP value marking operation for each packet based on the DSCP value created in the SMF for each packet for each media type within one SDF transmitted to the UPF.

As will be described in detail below, the sub QoS flow allocation operation may allocate appropriate QFI information corresponding to the media type, include appropriate QFI information within the PCC rule including QFI information for each packet and sub-QoS flow creation indicator information, and transmit the PCC rule to the SMF when creating a PCC rule in the PCF in the case of a sub QoS flow creation request operation that maps packets for each media type within one SDF transmitted to the UPF to each QoS flow. The corresponding QFI information may receive and utilize information that allocates 5QI values in consideration of service characteristics of video packets and audio packets from the PCF. Further, various 5QI values may be allocated according to the media type within the service flow, and different 5QI values may be allocated to the same video or audio packet according to the provider policy and the creation of a sub QoS flow considering this may be determined. The SMF that has received the corresponding PCC rule information may create each QER with QoS flow allocation information for each media packet based on protocol description information within the same PDR upon creating a PDR in the UPF. When video and audio packets are multiplexed and transmitted within one service flow, video packets and audio packets are classified and detected using protocol description information within PDR information for detection of the corresponding packet, and the corresponding packets are forwarded to a QoS flow having video and audio characteristics, and QFI information corresponding to the QoS flow may be marked. Thereafter, the SMF may transmit a QoS profile including QFI information of each sub-QoS flow to the RAN; thus, the RAN may perform a scheduling operation using information of the sub-QoS flow. Additionally, the SMF may transmit information on the corresponding sub-QoS flow to the UE using QoS rules.

As will be described in detail below, the sub QoS flow allocation operation may perform an operation of classifying packets for each media type within one SDF transmitted to the UPF through DSCP marking in consideration of media types of packets within one QoS flow. According to the policies and configurations of a service provider or a network provider, one SDF uses the same QoS flow without using a separate sub QoS flow, but it may request allocation of a sub QoS flow within the same QoS flow. In this case, the PCF may determine to perform a DSCP marking operation so as to distinguish packets for each media type within the same QoS flow. Thereafter, the PCF may include relevant 5QI and ARP information in the PCC rule and transmit the PCC rule to the SMF in consideration of a sub QoS flow classification indicator through DSCP marking and media characteristics within the corresponding service flow. The SMF that has received the DSCP marking indicator may determine a DSCP value based on 5QI and ARP information for DSCP marking, or use separate standardized DSCP value information (e.g., DSCP value 0 in the case of video, DSCP value 1 in the case of audio) provided for each network provider. When the DSCP value has been determined, the SMF may include detection rule information for distinguishing the packet based on the DSCP marking operation request, DSCP value information for each packet, and protocol description information in the PDR, and transmit the PDR to the UPF. When the multiplexed service flow is transmitted, the UPF may detect packets for each media type within the service flow, mark a DSCP value for each media type, and transmit the DSCP value to the RAN. The SMF may transmit QFI information mapped to the DSCP value to the RAN. The RAN may view the DSCP value of the packet in a specific QoS flow transmitted to the RAN based on the DSCP value and QoS mapping information to perform a QoS mapping operation of each packet. Thereafter, the RAN may identify QOS characteristics of each packet based on QoS mapped information for each packet and perform an RAN scheduling operation considering the QoS characteristics.

In 5GC, a network slice function is introduced. The 5GC should be able to support various UE types and services so as to meet requirements of 5G; Requirements for 5G may include, for example, an enhanced mobile broadband (eMBB), ultra reliable low latency communications (URLLC), or massive machine type communications (mMTC).

Each UE or service may have different requirements for a core network according to what service it supports. For example, an eMBB service may require a high data rate. An URLLC service may require high stability and low delay. As a result, network slice technology was proposed to meet requirements of 5G according to support of various services.

Specifically, network slicing may mean a method of virtualizing a single physical network to activate multiple logical networks (e.g., network slices). Each network slice activated through network slicing may be referred to as a network slice instance (NSI). Each NSI may have different characteristics. Mobile communication service providers may constitute a network function (NF) for each NSI that matches characteristics of the NSI to satisfy various service requirements according to the UE or service. For example, a mobile communication service provider may efficiently support various 5G services (e.g., eMBB, URLLC, or mMTC) by allocating to each UE an NSI that matches characteristics of a service required by each UE.

The 5GC may support a network virtualization paradigm through separation of a mobility management function and a session management function. All UEs in 4G long term evolution (LTE) may receive services from the network through signaling exchange with a single core entity called a mobility management entity (MME), which is responsible for registration, authentication, mobility management, and session management functions. However, in 5G, the number of UEs increases explosively (e.g., UEs performing machine type communications (MTC)), and the mobility and traffic or session characteristics that should be supported may be segmented according to a type of the UE. Accordingly, when all functions are supported by a single entity (e.g., MME), scalability of adding entities for each required function is inevitably reduced. Accordingly, various functions are being developed based on a structure that separates the mobility management function and the session management function in order to improve scalability in terms of the function or implementation complexity of the core entity responsible for the control plane and signaling load.

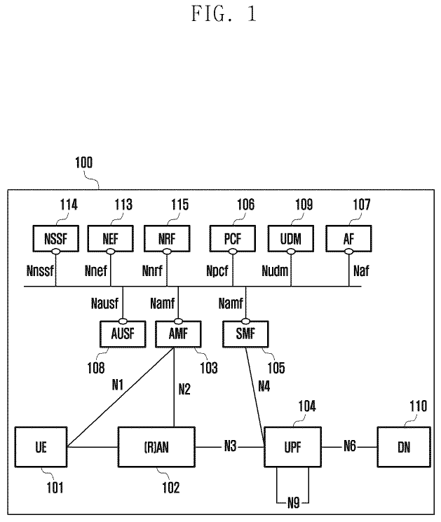

FIG. 1 illustrates a network structure and interface of a 5G system according to an embodiment.

Referring to FIG. 1, a network entity included in the network structure of the 5G system may include a network function (NF) according to system implementation.

A network structure of a 5G system 100 may include various network entities such as an authentication server function (AUSF) entity 108, an (core) access and mobility management function (AMF) entity 103, an SMF entity 105, a PCF entity 106, an AF entity 107, a unified data management (UDM)) entity 109, a data network (DN) 110, a network exposure function (NEF) entity 113, a network slicing selection function (NSSF) entity 114, a UPF entity 104, a (radio) access network (R)AN) 102, and a terminal (e.g., UE) 101.

Each NF entity of the 5G system 100 may support the following functions.

The AUSF 108 may process and store data for authentication of the UE 101.

The AMF 103 may provide functions for access and mobility management of a UE unit. The UE may be connected to one AMF per UE.

The AMF 103 may support at least one function of signaling between CN nodes for mobility between 3GPP access networks, termination of a RAN CP interface (e.g., N2 interface), termination of non-access stratum (NAS) signaling (e.g., N1 interface), NAS signaling security (e.g., NAS ciphering and integrity protection), AS security control, registration management (e.g., registration area management), connection management, idle mode UE reachability (e.g., including controlling and performing paging retransmission), mobility management control (e.g., subscription and policy), intra-system mobility and inter-system mobility support, support for network slicing, SMF selection, lawful intercept (e.g., AMF event and interface to a layer 1 (LI) system), providing transfer of session management (SM) messages between the UE and the SMF, transparent proxy for SM message routing, access authentication, access authorization including roaming authorization check, providing transfer of a short message service (SMS) message between the UE and the SMSF, security anchor function (SAF), or security context management (SCM). Some or all of functions of the AMF entity 103 may be supported within a single instance of one AMF entity.

The DN 110 indicates at least one of an operator service, Internet access, or a third party service. The DN 110 may transmit a DL PDU to the UPF entity 104 or receive a PDU transmitted from the UE 101 from the UPF entity 104.

The PCF entity 106 may receive information on packet flows from the AS. Through the received information, the PCF entity 106 may provide a function of determining at least one policy of mobility management or SM.

The PCF entity 106 may support at least one function of supporting a unified policy framework to govern a network operation, providing policy rules that enable a CP function entity(s) (e.g., AMF entity or SMF entity) to enforce policy rules, or implementing a front end (FE) for accessing relevant subscription information for policy determination within a user data repository (UDR).

The SMF entity 105 may provide an SMF. In this case, when the UE 101 has multiple sessions, each session may be managed by a different SMF entity.

The SMF entity 105 may support at least one function of SM (e.g., session establishment, modification, and termination including maintaining a tunnel between the UPF entity 104 and the (R)AN 102 node), UE Internet protocol (IP) address allocation and management (e.g., including optional authentication), selection and control of UP functions, traffic steering configuration for routing traffic from the UPF entity 104 to an appropriate destination, termination of interfaces toward PCFs, enforcement of policy and QoS control parts, lawful intercept (e.g., SM events and interfaces to LI systems), termination of an SM part of NAS messages, DL data notification, an initiator of AN specific SM information (e.g., including a process of transmitting to the (R)AN 102 through N2 via the AMF entity 103), session and service continuity (SSC) mode determination, or roaming function. Some or all of functions of the SMF entity 105 may be supported within a single instance of one SMF entity.

The UDM entity 109 may store at least one of user subscription data or policy data. The UDM entity 109 may include at least one of two parts, including an application FE or a UDR.

The FE may include a UDM FE responsible for at least one of location management, subscription management, or credential processing, and a PCF entity responsible for policy control. The UDR may store data required for functions provided by the UDM-FE and a policy profile required by the PCF entity. Data stored in the UDR includes at least one of user subscription data or policy data including a subscription identifier, security credential, access, mobility related subscription data, and session related subscription data. The UDM-FE may support at least one of access to subscription information stored in the UDR, authentication credential processing, user identification handling, access authentication, registration or mobility management, subscription management, or SMS management.

The UPF entity 104 may transmit a DL PDU received from the DN 110 to the UE 101 via the (R)AN 102. The UPF entity 104 may transmit a UL PDU received from the UE 101 to the DN 110 via the (R)AN 102.

The UPF entity 104 may support at least one function of an anchor point for intra or inter radio access technology (RAT) mobility, an external PDU session point for interconnection to a DN, packet routing and forwarding, user plane portion of packet inspection and policy rule enforcement, lawful intercept, traffic usage reporting, UL classifier for supporting traffic flow routing to a DN, branching points for supporting multi-homed PDU sessions, QoS handling for a user plane (e.g., packet filtering, gating, UL/DL rate enforcement), uplink traffic verification (e.g., SDF and SDF mapping between QoS flows), transport level packet marking in UL and DL, or DL packet buffering and DL data notification triggering functions. Some or all of functions of the UPF entity 104 may be supported within a single instance of one UPF.

The AF entity 107 may interoperate with a 3GPP CN to provide a service.

The AF entity 107 may support at least one function of application influence on traffic routing, access to network capability exposure, or interaction with a policy framework for policy control.

The (R)AN 102 refers to a new wireless access network supporting both evolved universal terrestrial radio access (E-UTRA), which is an evolved version of 4G radio access technology, and NR.

The gNB may support functions for radio resource management, at least one function of internet protocol (IP) header compression, encryption and integrity protection of user data string, selection of the AMF upon UE attachment because routing to the AMF is not determined from information provided to the UE, user plane data routing to the UPF(s), CP information routing to the AMF, connection setup and termination, scheduling and transmission of paging messages (e.g., paging messages originating from the AMF), scheduling and transmission of system broadcast information (e.g., system broadcast information originating from the AMF or operating and maintenance (O&M)), measurement and measurement reporting configuration for mobility and scheduling, transport level packet marking in the UL, SM, support for network slicing, QoS flow management and mapping to data radio bearers, support for UE in an inactive mode, distribution function of NAS messages, NAS node selection function, RAN sharing, dual connectivity, or tight interworking between NR and E-UTRA.

The gNB may support functions for radio resource management, for example, at least one function of radio bearer control, radio admission control, connection mobility control, or dynamic allocation (e.g., scheduling) of resources from a UE or DL to the UE.

The UE 101 may mean a user device such as a terminal, a mobile equipment (ME), or an MS. The user device may be a portable device such as a laptop computer, a mobile phone, a personal digital assistant (PDA), a smartphone, a multimedia device, etc. The user device may be a non-portable device such as a personal computer (PC) or vehicle-mounted device.

The NEF 113 may provide a function that securely exposes functions provided by 3GPP network functions.

The NEF 113 may provide a function that safely exposes services and capabilities for a third party, internal exposure or re-exposure, AFs, and edge computing. The NEF 113 may receive information from other NF(s) (e.g., information based on an exposed capability(s) of other NF(s)).

The NEF 113 may store received information as structured data using standardized interfaces to data storage network functions. The stored information may be re-exposed by the NEF entity 113 to other NF entity(s) and AF entity(s) and be used for other purposes, such as analysis.

An NRF 115 may support a service discovery function. The NRF 115 may receive an NF discovery request from an NF instance. Information on the discovered NF instance may be provided to the NF instance. The NRF 115 may maintain available NF instances and services in which they support.

For convenience of description, FIG. 1 illustrates a reference model when the UE 101 accesses one DN 110 using one PDU session, but the disclosure is not limited thereto.

The UE 101 may simultaneously access two or more (e.g., local and central) DNs using multiple PDU sessions. In this case, two or more SMFs may be selected for different PDU sessions. However, each SMF may have the capability to control both the local UPF and the central UPF within the PDU session.

The UE 101 may simultaneously access two or more (e.g., local and central) DNs provided within a single PDU session.

In the 3GPP system, a conceptual link connecting several NFs in the 5G system may be defined as a reference point. For example, the reference point(s) included in the 5G system 100 of FIG. 1 may be as follows.
N1 is the reference point between the UE 101 and the AMF 103
N2 is the reference point between the (R)AN 102 and the AMF 103
N3 is the reference point between the (R)AN 102 and the UPF 104
N4 is the reference point between the SMF 105 and the UPF 104
N5 is the reference point between the PCF 106 and the AF 107
N6 is the reference point between the UPF 104 and the DN 110
N7 is the reference point between the SMF 105 and the PCF 106
N8 is the reference point between the UDM 109 and the AMF 103
N9 is the reference point between two core UPFs 104
N10 is the reference point between the UDM 109 and the SMF 105
N11 is the reference point between the AMF 103 and the SMF 105
N12 is the reference point between the AMF 103 and the AUSF 108
N13 is the reference point between the UDM 109 and the AUSF 108
N14 is the reference point between two AMFs 103
N15 is the reference point between the PCF and the AMF in the case of a non-roaming scenario or reference point between the PCF and the AMF in a visited network in the case of a roaming scenario.

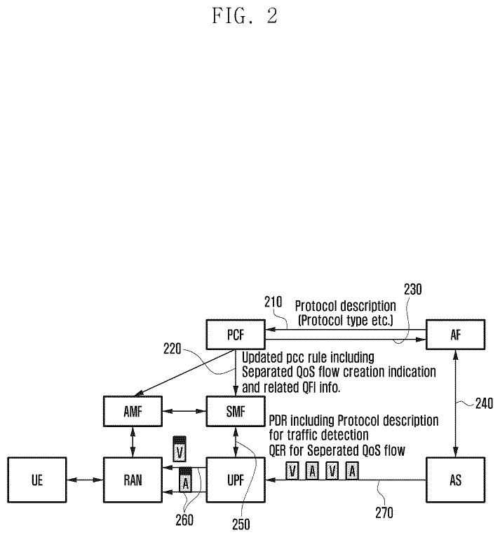

FIG. 2 illustrates an operation for classifying packets into grouping units in a wireless communication system according to an embodiment.

Referring to FIG. 2, packets of different media types (e.g., video and audio) may exist within a single service flow. In this case, a sub QoS flow may be created based on media type information in multiplexed SDFs. Packets multiplexed based on the created sub QoS flow may be classified into grouping units. Multiplexed packets may be processed for each sub QoS flow. For this purpose, classification information (e.g., DSCP marking) may be provided.

Specifically, packets of the same media type may exist within a single service flow. PDU set-based processing (e.g., IBP frame) within a single service flow and processing for each sub QoS flow may be considered simultaneously. Packets within a single sub QoS flow classified based on a sub QoS flow may need to be classified in units of a PDU set.

In FIG. 2, in step 210, the AF may request a sub QOS flow allocation service based on PDU set handling of the corresponding service flow, by the AF transmitting a protocol description to the PCF.

The protocol description may include at least one piece of information of a PDU set handling indication, a codec of packets for each media type, a sampling rate, a media constitution type within the service flow (e.g., information related to whether to multiplex within RTP packets such as Group_RTP_Bundle), or information on whether PDU set handling of packets in the corresponding service flow is provided from the AS (e.g., PDU set handling support for all pdu indication).

Considering characteristics of the packet, the AF may transmit a sub QoS flow allocation service request indicator (e.g., sub QoS flow support indicator) of multiplexed SDFs for utilizing QOS characteristic information for each packet in the RAN to the PCF.

The PCF may determine whether to accept a sub QoS flow allocation service request based on the sub QoS flow allocation service request indicator (e.g., sub QoS flow support indicator) received from the AF and information related to the sub QoS flow allocation service request indicator.

In step 220, when the PCF accepts the sub QoS flow allocation service request, the PCF may transmit information including an indicator for sub QoS flow handling (e.g., sub QoS flow support indicator or sub QoS flow handling indicator) received from the AF when creating or updating a PCC rule and information related to the indicator for the sub QoS flow handling to the SMF.

In step 230, when the PCF may not support sub QOS flow handling of multiplexed SDFs, the PCF may transmit a rejection message to the sub QoS flow allocation service request to the AF in response to a message related to AF requirements. Multiplexed SDFs may include a media type based on service requirements received from AF.

In step 240, when the AF may not support sub QoS flow handling of multiplexed SDFs, the AF may transmit a rejection message to the sub QoS flow allocation service request to the AS. Packets of different media types within the sub QoS flow allocation service may request provision of the sub QoS flow allocation service using each SDF.

The PCF may determine to provide a sub QoS flow handling service of multiplexed SDFs. When it is determined to provide a sub QoS flow handling service, the PCF may reflect characteristics of each media within the service flow to determine to allocate different QoS. The PCF may determine to update the PCC rule based on the sub QoS flow creation request related to the sub QoS flow handling SDF and information related to the sub QoS flow handling service.

The PCF may identify that separate QoS flow mapping and QFI information marking processing are required for each media type of packets in multiplexed SDFs from an indicator for sub QoS flow handling received from the AF.

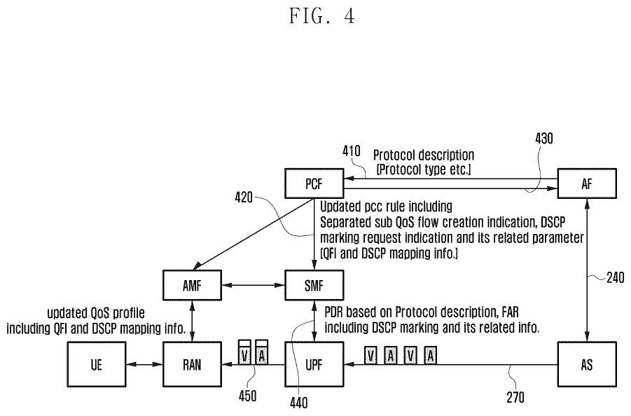

To support a sub QoS flow handling service of multiplexed SDFs according to the policy of a service provider or a network provider, the UPF may select a logical packet classification operation through DSCP marking within the same QoS flow as in the embodiment of FIG. 4 rather than through separate QoS flow allocation for each media type as in FIG. 2.

The SMF may receive a PCC rule including at least one of service indicator information for sub QoS flow handling, separate QFI allocation information for each media type related to sub QOS flow handling, or a protocol description from the PCF. The SMF may create PDR information for supporting a service for sub QoS flow handling to be transmitted to the UPF.

The protocol description transferred to the AF may include media type information of packets in the SDF. When the protocol description includes media type information of packets in the SDF, the PCF may create appropriate 5QI information for each media type of each packet based on the media type information.

In step 250, the SMF may transmit information for creating a QoS flow for each 5QI of the corresponding SDF and mapping to the QoS flow according to media characteristics for each packet to the UPF based on the created 5QI information. The UPF may receive a sub QoS flow creation request for each media type for sub QOS flow handling of multiplexed SDFs and information related to each QoS flow packet mapping from the SMF.

The UPF may identify multiplexed SDFs. The UPF may identify packets for each media type (e.g., video and audio) based on payload type information in the RTP packet header within the identified multiplexed SDF or information in the protocol description.

The UPF may perform a forwarding operation of packets based on PDR information received from the SMF. The forwarding operation of packets may be performed with a created QoS flow considering QoS characteristics for each packet identified for each media type.

In step 260, QOS mapping of packets and allocation of information may be performed considering characteristics of the media. Thereafter, the UPF may create a sub QoS flow and transmit the PDRs to the RAN. The PDR may be transmitted through each QoS flow. The SMF may transmit QOS rule information to the UE.

The RAN may identify QOS characteristics of each sub QoS flow based on QFI information in the QoS profile received from the SMF. The RAN may perform a scheduling operation for each packet based on QoS characteristics of the identified sub QoS flow.

For example, the PCF may receive information that a specific multiplexed SDF is composed of audio and video packets based on protocol descriptor information received from the AF. When the above information is received, to support a sub QoS flow service, the PCF may determine sub QoS flow information with audio (e.g., 5QI=1) and video (e.g., 5QI=2) considering QOS characteristic values related to 5QI for each media characteristic. The PCF may determine to create or update PCC rules including at least one of the corresponding sub QoS flow creation indicator, sub QoS flow information (e.g., audio (e.g., 5QI=1) and video (e.g., 5QI=2)), or protocol description information.

The PCF may transmit policy information including sub QoS flow service support information of multiplexed SDFs to the SMF. Through policy information transmission, the PCF may request the UPF to perform a sub QoS flow service operation of multiplexed SDFs.

Further in step 250, the SMF may request the UPF to create two different QoS flows for transmitting audio and video packets based on the created or updated PCC rule, and may create a PDR including a sub QoS flow service support indicator and QoS flow related mapping information and transmit the PDR to the UPF. QOS flow related mapping information may include a protocol description.

In step 270, the multiplexed SDFs may be transmitted from the AS to the UPF. The UPF may determine whether each packet is a video packet or an audio packet based on media type classification information in the protocol description. As a result, the UPF may classify and detect packets for each media type. In the case of audio packets, the UPF may forward packets, for example, using a QoS flow of QFI number 1 based on QFI information transmitted through QER. In the case of video packets, the UPF may forward packets, for example, using a QoS flow of QFI number 2.

The RAN may perform a RAN scheduling operation of packets received from the UPF with each sub QoS flow using QoS characteristics.

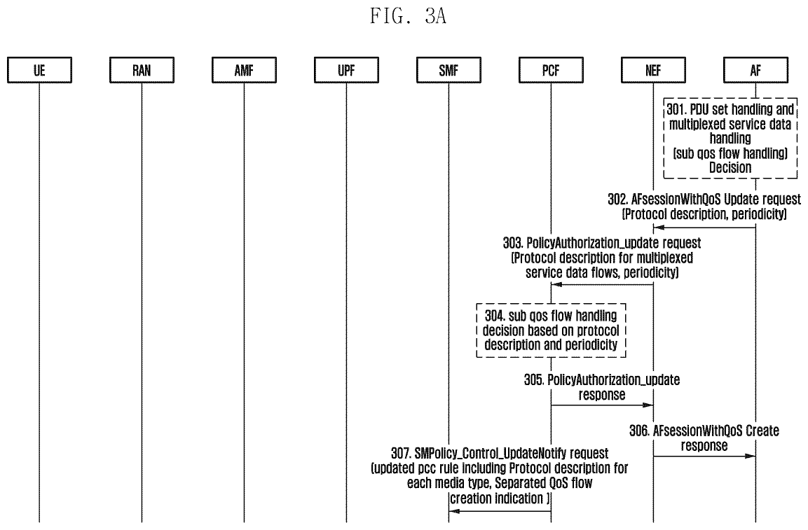

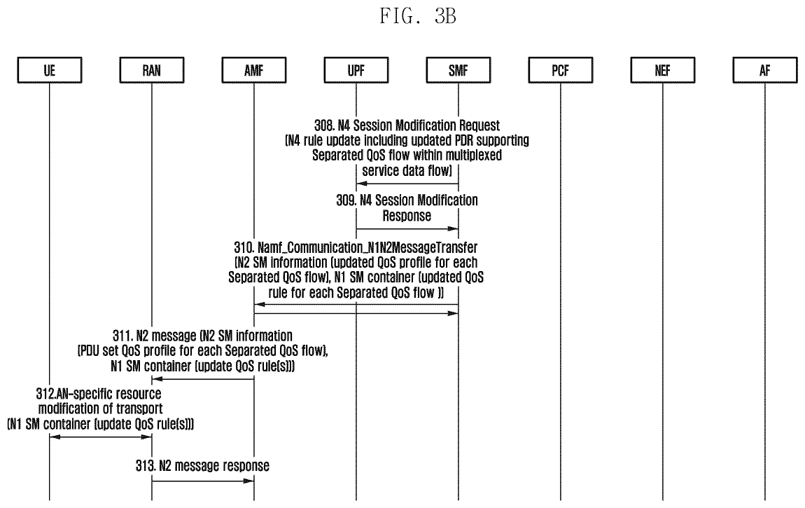

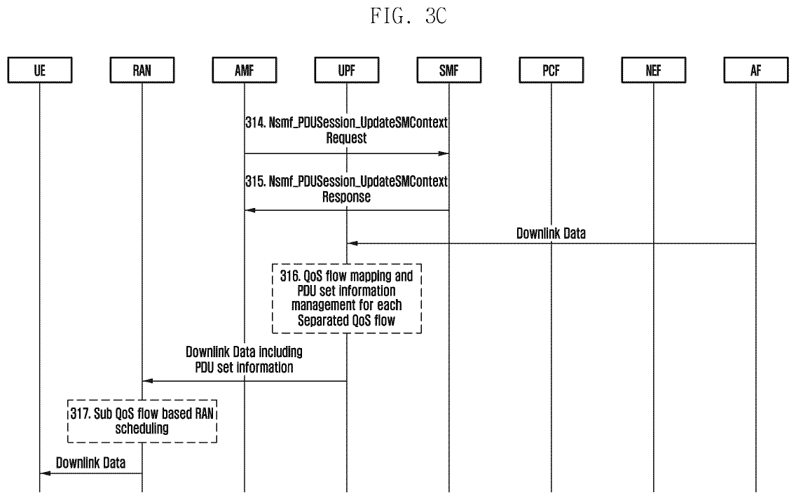

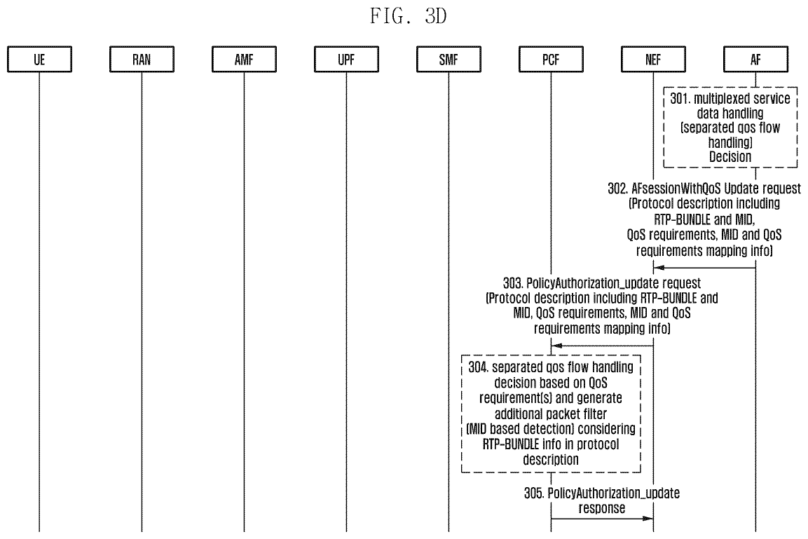

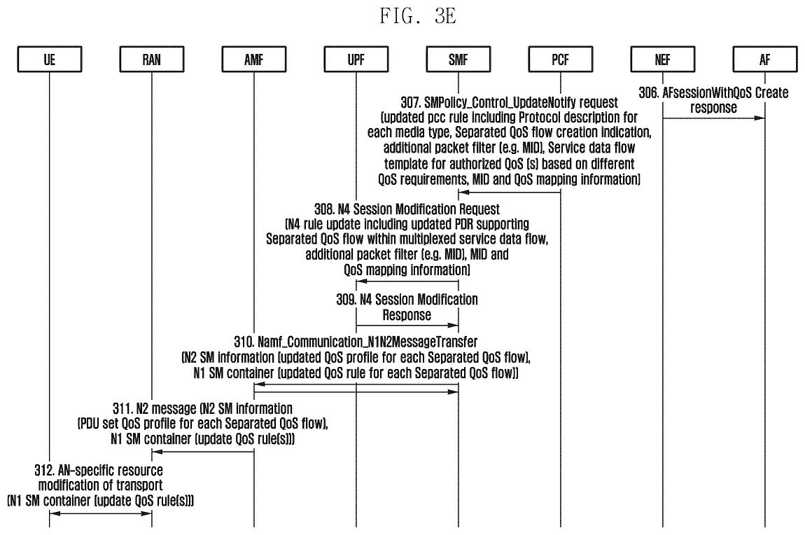

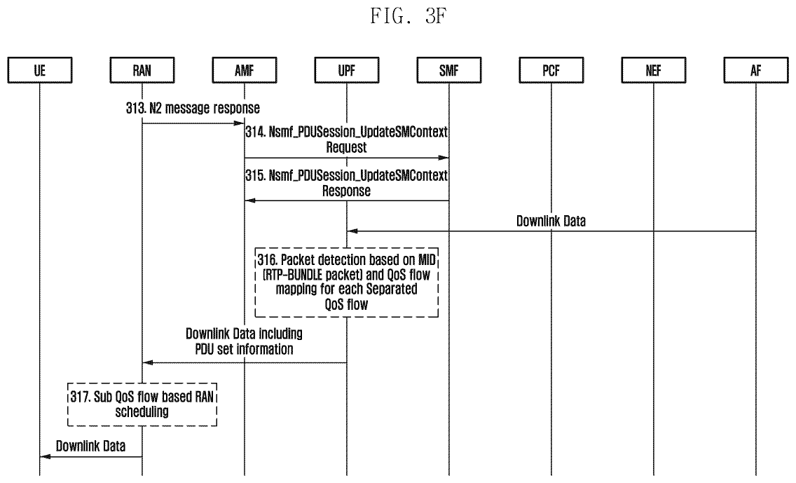

FIGS. 3A, 3B, and 3C illustrate a method of performing RAN scheduling in a wireless communication system according to an embodiment.

Referring to FIGS. 3A, 3B and 3C, the PCF may create a sub QoS flow of multiplexed SDFs based on requirements transmitted through the AF. The PCF may perform RAN scheduling considering media characteristics based on the sub QoS flow transmitted through AF.

In step 301, the AF may determine sub QoS flow creation support. The sub QOS creation support may be a PDU set-based service support and for classifying packets with different media types within a single service flow. The PDU set-based service and single service flow are intended to support scheduling in the RAN using PDU set information and sub QoS flow, and may use a service through multiplexed SDFs with packets having different media characteristics according to the user's selection or the service provider's policy.

In step 302, the AF may transmit information related to PDU set handling and sub QoS flow handling to the NEF based on the decision in step 301. Specifically, information related to PDU set handling and sub QoS handling may include at least one of a PDU set handling indication or a sub QoS flow creation support indicator (e.g., sub QoS flow support indicator or sub QoS flow handling indicator) to be used when supporting a PDU set-based service.

Information related to PDU set handling and sub QoS flow handling may be composed of a protocol description including at least one piece of information of a PDU set handling indication and a sub QoS flow handling indicator (e.g., sub QoS flow support indicator or sub QoS flow handling indicator) in the AF session related QoS requirement request message, a codec of packets for each media type, a sampling rate, multiplexed media constitution type within the service flow (e.g., Group_RTP_Bundle), or information on whether PDU set handling of packets within the corresponding service flow is provided from the AS (e.g., PDU set handling support for all pdu indication).

The AF may transmit an AF session related QOS requirement (e.g., AFsessionWithQoS) message to the NEF entity. The AF session related QoS requirement message may include at least one of a PDU set handling indication, a sub QoS flow handling indicator (e.g., sub QoS flow support indicator or sub QoS flow handling indicator), or information including a protocol description.

In step 303, the NEF may transmit a policy authorization (e.g., PolicyAuthorization) message to the PCF entity. The policy authorization message may include at least one of PDU set handling information to be used when supporting a service based on the PDU set received from the AF, a sub QOS flow handling indicator, or service-related requirements (e.g., PDU set information creation and related parameters).

In step 304, the PCF may determine whether to accept the service handling request based on an identifier for PDU set handling received from the AF, a sub QoS flow handling indicator, and information in the protocol description.

When the PCF accepts the service request, the PCF may transmit a protocol description to the SMF. The protocol description may include an identifier for handling a PDU set received from the AF when creating or updating a PCC rule, a sub QOS flow handling indicator, and SDF related information.

However, the PCF may not support a PDU set handling or sub QoS flow handling service for service flows. The PDU set handling for the service flow may include multiplexed media types based on service requirements received from the AF. In steps 305 and 306, when the PCF does not support a handling service, the PCF may transmit a rejection message to the service request to the AF through the NEF in response to the message related to the AF requirement.

In step 304, the PCF may determine to provide a sub QoS flow handling service of multiplexed SDFs. When the PCF determines to provide a sub QoS flow handling service, the PCF may reflect characteristics of each different media in the service flow to determine to allocate different QoS. Thereafter, the PCF may determine to update the PCC rule based on a sub QoS flow creation request related to the SDF and information related to the SDF.

The PCF may identify from the PDU set handling indicator received from the AF that a separate sub QoS handling process based on PDU set handling of packets in the service flow is performed in the RAN. For a separate sub QoS handling process, the PCF may use information related to sub QoS flow handling and PDU set handling when creating or updating PCC rules based on the protocol description or predefined information. The PCF may update PCC rules based on the sub QoS flow handling and PDU set handling related information.

Only packets of the same media type exist within a single service flow. Thus, only single sub QoS handling information may exist. An operation of classifying for each media type and mapping to sub QoS flow for each media type may be performed. However, in the case of processing sub QoS handling based on PDU set handling, packets without PDU set information may exist. Packets without PDU set information may create basic or dummy PDU set information. Thereafter, the basic or dummy PDU set information may be mapped to the sub QoS flow. In this case, basic PDU set information may be marked within the GTP-U extension header. Even within the same sub QoS flow, PDU set information received through the RTP extension header may be marked for each PDU set within the GTP-U extension header.

In steps 305 and 306, the PCF may transmit a policy authorization update request response (e.g., PolicyAuthorization_update response) and AF session related requirement update request response (e.g., AFsession WithQoSCreate response) message as a message related to update request acceptance to the AF through the NEF. The update request may be an update request for policies related to sub QoS flow handling and PDU set handling services related to the multiplexing SDF. The PCF may transmit a message related to acceptance of the update request to the AF through the NEF based on service requirements received from the AF through steps 302 and 303.

In step 307, the PCF may transmit updated PCC rules based on the protocol description to the SMF through a session policy control update notification (e.g., Npcf_SMPolicyControl_UpdateNotify) request message. The protocol description may include at least one of an indicator for supporting a PDU set handling service in the RAN, information related to a PDU set QoS profile, a sub QoS flow creation indicator for supporting a sub QoS flow handling service, information related to QFI of each sub QoS flow, or protocol information and media type information related to multiplexed SDFs.

In step 308, the SMF may transmit PDR information to the UPF through an N4 session modification request message. Specifically, PDR information may include at least one of sub QoS flow related information, filter information for packet detection for each media type within the service flow, PDU set information detection rules for supporting a PDU set-based service through the PCF, or PDU set handling information including related parameter information. The sub QoS related information may include at least one of a sub QoS flow creation indicator for supporting sub QoS handling received through the PCF in step 307 or QFI of the sub QoS flow.

In the case of processing sub QoS handling based on PDU set handling, basic or dummy PDU set information may be created for packets without PDU set information. The created basic or dummy PDU set information may be mapped to a sub QoS flow. In this case, basic PDU set information may be marked within the GTP-U extension header. Even within the same sub QoS flow, PDU set information received through the RTP extension header may be marked for each PDU set within the GTP-U extension header.

In step 309, the UPF may transmit a response (e.g., N4 session modification response) message to the service request in response to an N4 session modification request message to the SMF.

In step 310, the SMF may transmit N2 SM information and N1 SM container to the AMF through an NIN2 message transfer (e.g., Namf_Communication_NIN2MessageTransfer) message. The N2 SM information and N1 SM container may include updated QFI and QoS rules for each media type using sub QoS information in multiplexed SDFs based on PCC rules received from the PCF.

In step 311, the AMF may transmit N2 SM information and N1 SM container to the RAN using an N2 message. The N2 SM information and the N1 SM container may include at least one of sub QoS flow handling received in step 310, updated QFI for supporting the PDU set handling service, QoS rule, or PDU set QoS profile.

In step 312, the RAN may transmit an N1 SM container (e.g., AN-specific resource modification of transport) including updated QoS rules to the UE to support a sub QoS flow handling service.

In step 313, the AMF may receive a service related response (e.g., N2 message response) message of the UE and the RAN based on the information transmitted in step 311 from the RAN.

In step 314, the AMF may transmit the service related response message received in step 313 to the SMF to transmit an update request (e.g., Nsmf_PDUSession_UpdateSMContext Request) message for session related information.

In step 315, the SMF may transmit an update response (e.g., Nsmf_PDUSession_UpdateSMContext Response) message for session related information to the AMF in response to the update request message for session related information received in step 314.

In step 316, the UPF may classify and detect multiplexed packets based on RTP packet header information transmitted from the AS in the DN to the UPF through an N6 section considering characteristics for each media type.

Specifically, to perform a packet detection operation using the corresponding RTP packet header information, the UPF may perform a packet detection operation based on information in the protocol description received from the AF. The UPF may detect packets in multiplexed SDFs based on the PDR information received from the SMF through step 308 considering media characteristics. Thereafter, the UPF may map packets in the detected SDF to the sub QoS flow based on information created in the PCF. The sub QOS flow may request creation of a new QoS flow. Alternatively, when there is an existing QoS flow based on 5QI considering the corresponding media characteristics, the UPF may perform mapping to the corresponding QoS flow.

To support PDU set-based packet handling, the UPF may detect PDU set information in the RTP packet header extension field transmitted from the AS in the DN to the UPF through an N6 section.

In the case of a media type packet without PDU set-based information, the UPF may create basic PDU set information. The UPF that has been requested to perform a mapping operation to a PDU set-based sub QoS flow may transmit the detected or created basic PDU set information to the RAN through the GTP-U header. Specifically, PDU Set information may include at least one of a PDU set sequence number, an end PDU of the PDU set, a byte size of the PDU set (e.g., PDU set size in bytes), a PDU sequence number within a PDU set (e.g., PDU SN within a PDU Set), or PDU set importance. The UPF may mark PDU set information received through the RTP packet extension header or created in the UPF within the GTP-U extension header and transmit the information to the RAN.

In step 317, the RAN may perform a RAN scheduling operation considering media characteristics of packets in the multiplexed service flow using information constituting the sub QoS flow received from the SMF in step 311. The RAN may perform a PDU set-based RAN scheduling operation based on the PDU set QoS profile and PDU set information received from the SMF.

FIGS. 3D, 3E, and 3F are message flow diagrams illustrating a method of performing RAN scheduling in a wireless communication system according to an embodiment.

Referring to FIGS. 3D, 3E and 3F, the PCF may create one or more QoS flows based on one or more QoS requirements of multiplexed SDFs transmitted through the AF. The PCF may perform RAN scheduling considering media characteristics based on one or more QoS flows created based on one or more QoS requirements considering different media characteristics transmitted through the AF.

In step 301, the AF may determine to support creation of one or more QoS flows created based on one or more QoS requirements considering different media characteristics, to classify packets with different media types within a single service flow. Specifically, a single service flow is intended to support scheduling in the RAN using one or more QoS flows created based on one or more QoS requirements considering different media characteristics and may use a service through multiplexed SDFs with packets having different media characteristics according to the user's selection or the service provider's policy. Multiplexed SDFs may be composed of an RTP-BUNDLE, wherein packets within the SDF composed of the RTP-BUNDLE may be distinguished based on media identification (MID) in RTP SDES compact header extensions. At least one piece of information of MID information for distinguishing bundled RTP packets or QoS requirement information (e.g., bandwidth, latency) mapped to MID information may be included in the protocol description. The protocol description may include information indicating that the MID is transmitted through RTP SDES compact header extensions. For example, at least one piece of information of “urn: ietf: params: rtp-hdrext: sdes: mid” or “urn: 3gpp: additional-packet-filter-mid:rel-19” may transfer or indicate that MID information is included in the extension header of an RTP packet transferred from the AS, and transfer or indicate that the corresponding information may be used in the additional packet filter.

In step 3302, the AF may transmit one or more QoS flow handling related information created based on one or more QOS requirements considering different media characteristics to the NEF based on the decision in step 301. Specifically, one or more QoS handling related information created based on one or more QoS requirements considering different media characteristics may include at least one of one or more QoS flow creation support indicators (e.g., separate QoS flow support indicator or separate QoS flow handling indicator) considering different media characteristics, an additional packet filter support indication, or one or more QoS requirements considering different media characteristics.

One or more QoS flow handling related information created based on one or more QoS requirements considering different media characteristics may include a protocol description including at least one piece of information of one or more QoS flow handling indicators (e.g., separate QoS flow support indicator or separate QoS flow handling indicator) considering different media characteristics in an AF session related QoS requirement request message 302, a codec of packets for each media type, a sampling rate, a multiplexed media constitution type in a service flow (e.g., at least one of Group_RTP_Bundle or RTP-BUNDLE), an additional packet filter support indication, or one or more QoS requirement information considering different media characteristics.

The AF may transmit an AF session related QoS requirement (e.g., AFsession WithQoS update request) message to the NEF entity. The AF session related QoS requirement message may include at least one of one or more QoS flow handling indicators (e.g., separate QoS flow support indicator or sub QoS flow handling indicator) considering different media characteristics, one or more QoS requirements related to multiplexed SDFs composed of different media types, a protocol type of SDF and packet distinguishing information (e.g., at least one of a payload type, synchronization source (SSRC), or message identifier (MID)) for distinguishing packets within multiplexed SDFs, or information including a protocol description including an additional packet filter support indicator.

In step 303, the NEF may transmit a policy authorization (e.g., PolicyAuthorization update request) message to the PCF entity. The policy authorization message may include at least one of one or more QoS flow handling indicators (e.g., separate QoS flow handling indicator) or service related requirements considering different media characteristics received from the AF. Specifically, service related requirements may include at least one of one or more QoS requirements related to multiplexed SDFs composed of different media types, a protocol type of the SDF, packet identification information (e.g., at least one of a payload type, SSRC, or MID) for distinguishing packets within multiplexed SDFs, and a protocol description including an additional packet filter support indicator.

In step 304, the PCF may identify whether the service handling request is accepted. The PCF may identify whether to accept the service handling request based on one or more QoS flow handling/support indicators (e.g., separate QoS flow handling indicator) considering different media characteristics received from the AF and information in the protocol description. The protocol description may include one or more QoS requirements related to multiplexed SDFs composed of different media types, a protocol type of the SDF, and packet classification information (e.g., at least one of a payload type, SSRC, or MID) for distinguishing packets within multiplexed SDFs. Packet classification information (e.g., at least one of a payload type, SSRC, or MID) for distinguishing packets in multiplexed SDFs in the protocol description may be different for each AS.

The PCF may accept the service request. When the PCF accepts the service request, the PCF may transmit a protocol description to the SMF. The protocol description may include at least one of SDF related information or one or more QoS flow handling indicators (e.g., separate QoS flow handling indicator) considering different media characteristics received from the AF when creating or updating PCC rules. The PCF may create a SDF filter(s) including existing 5-tuple based IP packet filters or additional packet filters using packet distinguishing information (e.g., payload type, SSRC, or MID) for classifying packets within multiplexed SDFs based on information in the protocol description.

In the case of multiplexed SDFs composed of an RTP-BUNDLE based on one or more QoS requirements related to multiplexed SDFs received from the AF and RTP-BUNDLE information and packet header information (“urn: ietf: params: rtp-hdrext: sdes: mid” or “urn: 3gpp: additional-packet-filter-mid: rel-19”) within the protocol description, it can be seen that the PCF may distinguish packets within multiplexed SDFs based on MID within RTP SDES compact header extensions. Based on the above information, the PCF may perform an operation of creating or updating PCC rules for supporting a multiplexed SDF handling service using one or more QoS flows including additional packet filter information that detects packets based on a 5-tuple-based IP packet filter of the additional packet filter and MID information.

The PCF may not support a multiplexed SDF handling service using one or more QoS flows considering different media characteristics for service flows.

In steps 305 and 306, when the PCF does not support a handling service, the PCF may transmit a rejection message to the service request to the AF through the NEF in response to the message related to the AF requirement.

In step 304, the PCF may determine to provide a packet handling service using one or more QoS flows considering different media characteristics of multiplexed SDFs. When the PCF determines to provide a multiplexed SDF handling service using one or more QoS flows considering different media characteristics, the PCF may determine to allocate different QoS based on characteristics of each different media in the service flow. The PCF may determine to update the PCC rule based on the sub QoS flow creation request related to the SDF and information related to the SDF.

The PCF may identify that one or more QoS handling processes considering separate different media characteristics are performed in the RAN based on at least one of one or more QoS requirement information or additional packet filter support indication information considering different media characteristics received from the AF. For one or more QoS handling processes considering separate different media characteristics, the PCF may use one or more QoS flow handling and related information considering different media characteristics based on at least one of the protocol description or predefined information when creating or updating PCC rules. The PCF may update PCC rules based on the sub QoS flow handling and PDU set handling related information. When the PCF receives one or more QOS requirements from the AF in relation to one multiplexed SDF, the PCF may create SDF filter information including an indicator for a sub QoS handling operation or additional packet filter and create and update PCC rules including an additional packet filter support indication. The PCF may create a SDF template for authorized QoS based on QoS requirements received from the AF and transmit the SDF template to the SMF through PCC rules.

In steps 305 and 306, the PCF may transmit a policy authorization update request response (e.g., PolicyAuthorization_update response) and AF session related requirement update request response (e.g., AFsessionWithQoS Create response) message as a message related to update request acceptance to the AF through the NEF. The update request may be for one or more QoS flow handling and related policies considering different media characteristics related to the multiplexing SDF. The PCF may transmit a message related to acceptance of the update request to the AF through the NEF based on service requirements received from the AF through steps 302 and 303.

In step 307, the PCF may transmit the updated PCC rule based on the protocol description to the SMF through a session policy control update notification (e.g., Npcf_SMPolicyControl_UpdateNotify) request message. The protocol description may include at least one of one or more QoS flow creation indicators considering different media characteristics for supporting one or more QoS flow handling services considering different media characteristics in the RAN, a QoS related SDF template of one or more QoS flows, protocol information and packet distinguishing information (e.g., media type information, MID, or SSRC, etc.) related to multiplexed SDFs, or additional packet filter support indication.

In step 308, the SMF may transmit PDR information to the UPF through an N4 session modification request message. The PDR information may include at least one of one or more QoS flow related information considering different media characteristics, or filter information (e.g., MID, payload type, or SSRC) for packet detection within the multiplexed service flow. The sub QOS related information may include at least one of a sub QOS flow creation indicator for supporting sub QoS handling received through the PCF in step 307 or QFI of the sub QoS flow. In addition to the existing 5-tuple-based IP packet filter in the PCF, an additional packet filter may be created to distinguish media packets in multiplexed SDFs and transmitted through the PDR. Additional packet filter information for distinguishing media packets within multiplexed SDFs may classify packets based on a payload type, SSRC, and MID information in the packet header and forward the packets with an appropriate QoS flow. In the case of an RTP SDF multiplexed in the form of a bundle, at least one of MID information or mapping information of the QoS flow related to the MID may be additionally received from the SMF.

The UPF may first detect multiplexed SDFs composed of RTP-BUNDLE transferred from the AS through an IP packet filter. Thereafter, the UPF may detect packets for each MID using an additional packet filter based on the MID received from the PCF through multiplexed SDFs composed of the corresponding RTP-BUNDLE. The UPF may perform a forwarding operation of packets detected for each MID with an appropriate QoS flow using MID and QoS flow mapping information created by the PCF or the SMF based on QoS requirements considering service characteristics of packets received from the AF.

In step 309, the UPF may transmit a response (e.g., N4 session modification response) message to the service request in response to the N4 session modification request message to the SMF.

In step 310, the SMF may transmit N2 SM information and N1 SM container to the AMF through an NIN2 message transfer (e.g., Namf_Communication_NIN2MessageTransfer) message. The N2 SM information and N1 SM container may include QFI and QoS rules for updated each media type based on one or more QoS information considering different media characteristics within multiplexed SDFs based on the PCC rules received from the PCF.

In step 311, the AMF may transmit N2 SM information and N1 SM container to the RAN using an N2 message. The N2 SM information and the N1 SM container may include at least one of an updated QFI, QOS rule, or QoS Profile for supporting one or more QOS flow handling considering different media characteristics received in step 360.

In step 312, the RAN may transmit an N1 SM container (e.g., AN-specific resource modification of transport) including updated QoS rules to the UE to support a sub QoS flow handling service.

In step 313, the AMF may receive a service related response (e.g., N2 message response) message of the UE and the RAN from the RAN for the N2 SM information and the N1 SM container based on information in the N2 message.

In step 314, the AMF may transmit a service related response message to the SMF. The AMF may transmit an update request (e.g., Nsmf_PDUSession_UpdateSMContext Request) message for session related information to the SMF.

In step 315, the SMF may transmit an update response (e.g., Nsmf_PDUSession_UpdateSMContext Response) message to session related information to the AMF in response to the update request message for session related information.

In step 316, the UPF may classify and detect multiplexed packets based on RTP packet header information transmitted from the AS in the DN to the UPF through an N6 section based on characteristics for each media type.

Specifically, to perform a packet detection operation using the corresponding RTP packet header information, the packet detection operation may be performed based on information in the protocol description received from the AF. The UPF may detect packets in multiplexed SDFs based on media characteristics and based on the PDR information received from the SMF in step 318. Thereafter, the UPF may map packets in the SDF detected through the additional packet filter to the sub QoS flow created in the PCF. The UPF may map detected packets to appropriate QoS flows based on (sub) QoS flows created based on QoS requirements considering different media characteristics, QoS requirements considering different media characteristics, and mapping information between packets. The sub QoS flow may request creation of a new QoS flow. Alternatively, when there is an existing QoS flow based on 5QI considering the corresponding media characteristics, mapping to the corresponding QOS flow may be performed.

In step 317, the RAN may perform RAN scheduling considering media characteristics of packets in the multiplexed service flow based on information constituting the sub QoS flow.

FIG. 4 illustrates an operation for performing RAN scheduling in a wireless communication system according to an embodiment.

Referring to FIG. 4, different media types (e.g., video and audio) may exist within a single service flow. In this case, DSCP marking may be performed using a created DSCP value based on 5QI information of packets. Based on the marked DSCP, multiplexed packets within one QoS flow may be distinguished, and a RAN scheduling operation through the distinguished packets may be performed.

In FIG. 4, in step 410, the AF may create a protocol description and transmit the protocol description to the PCF.

The protocol description may include at least one of a PDU set handling indication for requesting a service based on PDU set handling of the corresponding service flow, a codec of packets for each media type, a sampling rate, a media constitution type within the service flow (e.g., information on whether multiplexing within the RTP packet such as group_RTP_Bundle), or information on whether PDU set handling of packets in the corresponding service flow is provided from the AS (e.g., PDU set handling support for all pdu indication).

In the case of processing sub QoS handling based on PDU set handling, packets without PDU set information may create basic or dummy PDU set information. The created basic or dummy PDU set information may be mapped to a sub QoS flow. In this case, basic PDU set information may be marked within the GTP-U extension header. Further, even within the same sub QoS flow, PDU set information received through the RTP extension header may be marked for each PDU set within the GTP-U extension header. The AF may transmit a sub QoS flow allocation service request indicator to the PCF for utilizing QoS characteristic information for each packet in the RAN considering packet characteristics of multiplexed SDFs.

The PCF may determine whether to accept the corresponding request based on the sub QoS flow allocation service request indicator (e.g., sub QoS flow support indicator) and information related to the sub QoS flow allocation service request indicator received from the AF.

In step 420, when the PCF may accept the sub QOS flow allocation service request, the PCF may include an indicator for handling the sub QoS flow (e.g., sub QoS flow support indicator or sub QoS flow handling indicator) received from the AF when creating or updating a PCC rule and information related to the indicator for sub QoS flow handling and transmit the PCC rule to the SMF.

The PCF may not support sub QoS flow handling of multiplexed SDFs including different media types based on the service requirements received from the AF.

In step 430, when sub QoS flow handling of the SDF is not supported, the PCF may transmit a rejection message to the sub QoS flow allocation service request to the AF in response to a message related to AF requirements.

When the AF may not support sub QoS flow handling of multiplexed SDFs, the AF may transmit a message related to the inability to support sub QoS flow handling to the AS. The AF may request the AS to provide services for packets of different media types of the corresponding service using each SDF.

According to policies and configurations of a service provider or a network provider, the PCF may request sub QoS flow allocation within the same QoS flow while using the same QoS flow for one SDF without using a separate sub QoS flow. The PCF may determine to perform a DSCP marking operation to distinguish packets for each media type within the same QoS flow. The PCF may include relevant 5QI and ARP information in the PCC rule considering a sub QoS flow classification indicator through DSCP marking and media characteristics within the corresponding service flow and transmit the PCC rule to the SMF.

The PCF may determine to provide a sub QoS flow handling service of multiplexed SDFs. When it is determined to provide a sub QoS flow handling service, the PCF may determine to allocate QoS information for distinguishing packets reflecting each media characteristic within the service flow. The PCF may determine to update the PCC rule based on a DSCP marking request related to the sub QoS flow handling SDF and information related to SDF. The PCF may identify from an indicator for sub QoS flow handling received from the AF that a packet classification operation is required through separate DSCP marking for each media type of packets in the corresponding SDF.

To support a sub QoS flow handling service of multiplexed SDFs according to the policy of a service provider or a network provider, the UPF may perform classification for each packet through separate QoS flow allocation for each media type as in the embodiment of FIG. 2 or may select a logical packet classification operation through DSCP marking within the same QoS flow as in the embodiment of FIG. 4.

The SMF may receive a PCC rule including at least one of service indicator information for sub QoS flow handling, separate QFI allocation information for each media type related to sub QoS flow handling, DSCP marking indication information, or protocol description from the PCF. The SMF may create PDR information for supporting a service for sub QoS flow handling to be transmitted to the UPF.

The protocol description transferred to the AF may include media type information of packets in the SDF. When the protocol description includes media type information of packets in the SDF, the PCF may create appropriate 5QI information for each media type of each packet based on the corresponding media type information.

The sub QoS flow allocation operation may perform an operation of classifying packets through DSCP marking considering a media type of packets within one QoS flow for the packet for each media type within one SDF transmitted to the UPF.

The SMF that has received the DSCP marking indicator may determine a DSCP value based on 5QI and ARP information for DSCP marking. Alternatively, the SMF may determine a DSCP value (e.g., DSCP value 0 in the case of video, DSCP value 1 in the case of audio) based on separate standardized DSCP value information provided for each network provider.

In step 440, when the DSCP value is determined, the SMF may perform the corresponding DSCP marking operation request. The SMF may include detection rule information for classifying the corresponding packet in the PDR and transmit the PDR to the UPF based on DSCP value information and protocol description information for each packet.

The SMF may transmit information for creation of QOS flow for each 5QI of the corresponding SDF and QoS flow mapping according to media characteristics for each packet to the UPF.

The SMF may transmit QFI information mapped to DSCP values to the RAN.

The UPF may receive DSCP marking and DSCP related information for each media type (e.g., DSCP value and media type mapping info or DSCP table based on QoS info) for sub QoS flow handling of multiplexed SDFs from the SMF.

The UPF may detect multiplexed SDFs and then detect packets for each media type (e.g., video and audio) based on payload type information in the RTP packet header within the corresponding SDF or information in the protocol description.

The UPF may perform DSCP marking for each media packet based on DSCP information received from the SMF for the packet for each media type. The UPF may perform DSCP marking within the outer IP header and distinguish packets within the same QoS flow based on the corresponding DSCP value. Through the packet classification process, the UPF may identify that packets with different media characteristics have different DSCP values.

In step 450, the UPF may transmit different DSCP values to the RAN through the same QOS flow.

The RAN may identify QOS characteristics of each sub QoS flow based on QFI information in the QoS profile received from the SMF. The RAN may perform a scheduling operation for each packet based on QoS characteristics of the identified sub QoS flow.

For example, the PCF may receive information that a specific multiplexed SDF is composed of audio and video packets based on protocol descriptor information received from the AF. In the case of receiving the above information, the PCF may determine a DSCP marking operation based on sub QoS flow information with audio (e.g., 5QI=1) and video (e.g., 5QI=2) considering 5QI and related QoS characteristic values for each media characteristic to support a sub QoS flow service. The PCF may determine to create or update PCC rules which may include at least one of a DSCP marking indicator for distinguishing sub QoS flows, sub QoS flow information (e.g., audio (e.g., 5QI=1) and video (e.g., 5QI=2)), or protocol description information.

The PCF may transmit policy information including support information for the sub QoS flow service of multiplexed SDFs to the SMF. The PCF may request the SMF to perform the sub QoS flow service operation of multiplexed SDFs in the UPF.

Based on the PCC rule, the SMF may request a DSCP marking operation for distinguishing audio and video packets within the same QoS flow to the UPF in step 440. The SMF may create a PDR including at least one of a DSCP marking operation indicator for supporting a sub QoS flow service, a DSCP value including a protocol description, or mapping information between audio and video media packets and transmit the PDR to the UPF in step 440.

Multiplexed SDFs may be transmitted from the AS to the UPF. The UPF may determine whether each packet is a video packet or an audio packet based on media type classification information in the protocol description. The UPF may classify and detect packets for each media type based on the determination result. Based on the DSCP information transmitted through the FAR, for example, in the case of audio, the UPF may perform a DSCP marking operation within an outer IP header with a DSCP value of 1. For example, in the case of a video packet, the UPF may perform a DSCP marking operation within the outer IP header with a DSCP value of 2.

The RAN may distinguish packets transmitted through the same QoS flow from the UPF based on the DSCP value in the header of the corresponding packets. For example, a packet with a DSCP value of 1 may be recognized as an audio packet. For example, a packet with a DSCP value of 2 may be recognized as a video packet.

The RAN may identify QoS characteristics of video and audio packets transmitted to the RAN based on the DSCP value and 5QI mapping information transmitted from the SMF. The RAN may perform a RAN scheduling operation for each packet of different media types such as audio and video based on the corresponding information.

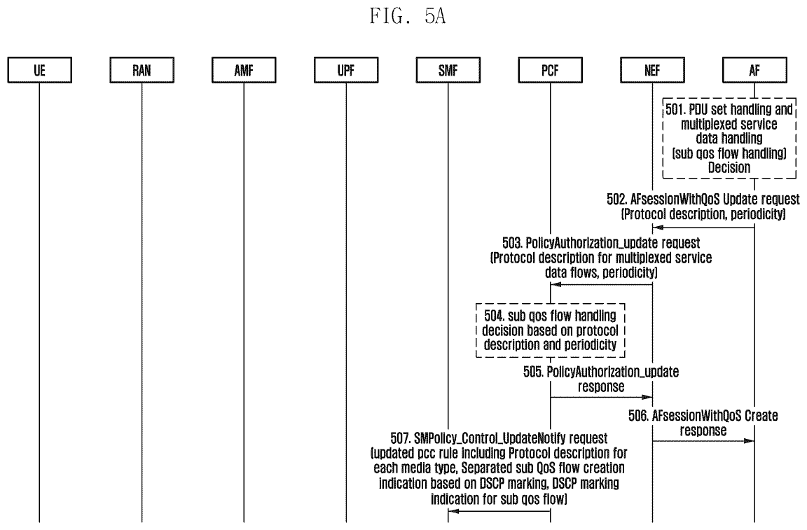

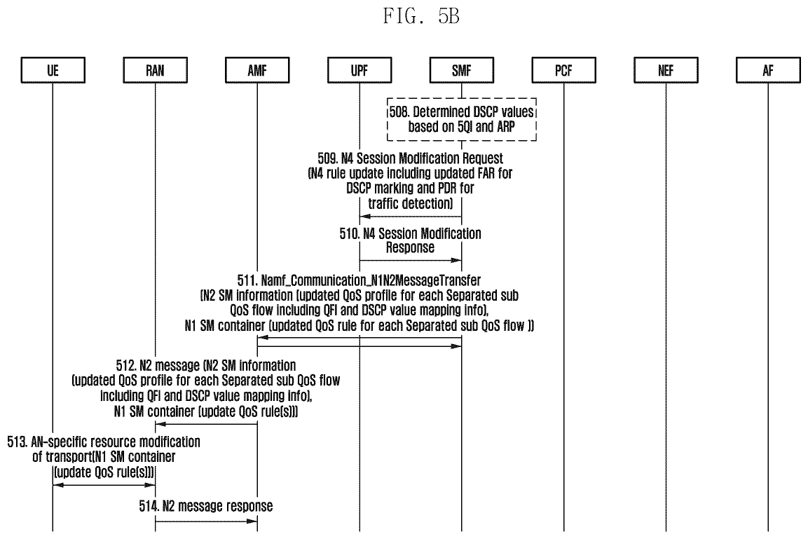

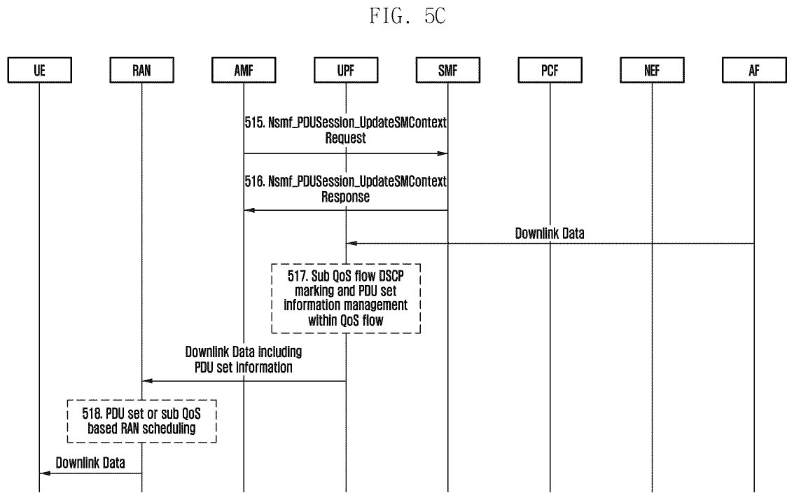

FIGS. 5A, 5B, and 5C are message flow diagrams illustrating a method of performing a RAN scheduling operation in a wireless communication system according to an embodiment.

Referring to FIGS. 5A, 5B and 5C, the RAN scheduling operation may be performed based on DSCP marking for sub QoS flow classification of multiplexed SDFs transmitted through the AF and media characteristics of packets classified through DSCP in the RAN.

In step 501, the AF may determine sub QoS flow creation support. Specifically, sub QoS creation support may be a PDU set-based service support and for distinguishing packets with different media types within a single service flow. The PDU set-based service and single service flow are intended to support scheduling in the RAN using PDU set information and sub QoS flow, and may use a service through multiplexed SDFs with packets having different media characteristics according to the user's selection or the service provider's policy.

In step 502, the AF may transmit information related to PDU set handling and sub QoS flow handling to the NEF based on the decision in step 501. Specifically, information related to PDU set handling and sub QoS handling may include at least one of a PDU set handling indication or a sub QoS flow creation support indicator (e.g., sub QoS flow support indicator or sub QoS flow handling indicator) to be used when supporting a PDU set-based service.

Information related to PDU set handling and sub QoS flow handling may be composed of protocol description including at least one piece of information of a PDU set handling indication, a sub QoS flow handling indicator (e.g., sub QoS flow support indicator or sub QoS flow handling indicator) in the AF session related QoS requirement request message 502, a codec of packets for each media type, a sampling rate, a multiplexed media constitution type within the service flow (e.g., Group_RTP_Bundle), or information on whether PDU set handling is provided (e.g., PDU set handling support for all pdu indication) of packets within the corresponding service flow from the AS.

The AF may transmit an AF session related QOS requirement (e.g., AFsessionWithQoS) message to the NEF entity. The AF session related QoS requirement message may include at least one of a PDU set handling indication, a sub QoS flow handling indicator (e.g., sub QoS flow support indicator or sub QoS flow handling indicator), or protocol description.

In step 503, the NEF may transmit a policy authorization (e.g., PolicyAuthorization) message to the PCF entity. The policy authorization message may include at least one of PDU set handling information to be used when supporting a PDU set-based service received from the AF, a sub QoS flow handling indicator, or service related requirements (e.g., PDU set information creation and related parameters).

In step 504, the PCF may determine whether to accept a service handling request. The PCF may determine whether to accept a service handling request based on an identifier for PDU set handling received from the AF, a sub QoS flow handling indicator, and information in the protocol description.

In case that the PCF accepts the service request, the PCF may transmit a protocol description to the SMF. The protocol description may include an identifier for handling the PDU set received from the AF when creating or updating a PCC rule, a sub QoS flow handling indicator, and SDF related information.

However, PDU set handling or sub QoS flow handling services for PCF service flows may not be supported. PDU set handling for the service flow may include a multiplexed media type based on service requirements received from the AF. In case that the PCF does not support a handling service, in steps 505 and 506, the PCF may transmit a rejection message to the service request to the AF through the NEF in response to the message related to the AF requirement.

In step 504, the PCF may determine to provide a sub QOS flow handling service of multiplexed SDFs. When the PCF determines to provide a sub QOS flow handling service, the PCF may reflect characteristics of each different media in the service flow to determine to allocate different QoS. Thereafter, the PCF may determine to update the PCC rule based on a DSCP marking operation and DSCP marking related information (e.g., 5QI, ARP) for distinguishing packets with different media characteristics.

The PCF may identify that separate sub QoS handling is performed in the RAN based on PDU set handling of packets in the corresponding service flow from the PDU set handling indicator received from the AF. For a separate sub QoS handling process, the PCF may use information related to sub QoS flow handling and PDU set handling when creating or updating PCC rules based on the protocol description or predefined information. The PCF may update PCC rules based on the sub QoS flow handling and PDU set handling related information.

The PCF may determine to provide a sub QoS flow handling service based on PDU set. In this case, some media types of packets may not provide separate PDU set information through an RTP extension header. When separate PDU set information is not provided, the PCF may perform an update operation through a PCC rule including indication information of an operation of adding basic or dummy PDU set information.

In steps 505 and 506, the PCF may transmit a policy authorization update request response (e.g., PolicyAuthorization_update response) and AF session related requirement update request response (e.g., AFsessionWithQoSCreate response) message as a message related to update request acceptance to the AF through the NEF. The update request may be an update request for policies related to sub QoS flow handling and PDU set handling services related to the multiplexing SDF. The PCF may transmit a message related to acceptance of the update request to the AF through the NEF based on service requirements received from the AF in steps 502 and 503.

Information related to the service may be included in the message on whether to accept the update request according to service requirements transferred to the AF. Information related to the service may be classified and provided into a sub QoS flow-based service or a PDU set-based sub QoS flow service. The information may include service information accepted from the PCF and be transmitted.

In step 507, the PCF may transmit the updated PCC rule based on the protocol description to the SMF through a session policy control update notification (e.g., Npcf_SMPolicyControl_UpdateNotify) request message. The protocol description may include at least one of information related to 5QI of each sub QoS flow and a DSCP information marking operation indicator within a packet outer IP header based on information related to a PDU set QoS profile and an indicator for supporting a PDU set handling service in the RAN, and information on different media packets within the same QoS flow for distinguishing sub QoS flows for supporting a sub QoS flow handling service, protocol information related to multiplexed SDFs, or media type information.

In step 508, the SMF that has received a DSCP information marking operation indicator in the packet outer IP header from the PCF based on information on different media packets in the same QoS flow for distinguishing sub QoS flows may determine a DSCP value. The DSCP value is information used for distinguishing between packets when marking, and the SMF may create a DSCP value based on 5QI and ARP information. When the DSCP value is currently being used in another service of the network, the SMF may detect a DSCP value not used in another service based on a 5QI value received from the PCF and randomly map the DSCP value to 5QI to allocate the DSCP value.

In step 509, the SMF may transmit PDR information to the UPF through an N4 session modification request message. The PDR information may include at least one of sub QoS flow related information or filter information for packet detection for each media type within the service flow. In the case of a PDU set-based sub QoS flow handling service, the PDR information may include at least one of PDU set information detection rules for supporting a PDU set-based service, dummy PDU set information creation rules for packets in which PDU set information is not transferred, or PDU set handling information including related parameter information through the PCF. The sub QoS related information may include at least one of a sub QoS flow creation indicator for supporting sub QoS handling received through the PCF in step 507 or QFI of the sub QoS flow.

In step 510, the UPF may transmit a response (e.g., N4 session modification response) message to the service request in response to the N4 session modification request message to the SMF.

In step 511, the SMF may transmit N2 SM information to the AMF through an N1N2 message transfer (e.g., Namf_Communication_NIN2MessageTransfer) message. The N2 SM information and N1 SM container may include at least one of information received from the PCF, updated QFI and DSCP values, or 5QI mapping information. The QFI may be updated to transmit information for distinguishing a sub QOS within multiplexed SDFs to the RAN based on the DSCP value created in the SMF. In the case of a PDU set-based sub QoS flow handling service, PDU set QoS profile information created in the PCF or received from the AF may be included in N2 SM information and transmitted.

In step 512, the AMF may transmit N2 SM information to the RAN using an N2 message. Specifically, N2 SM information may include at least one of updated QFI and DSCP values, 5QI mapping information, or PDU set QoS profile to support sub QoS flow handling and PDU set handling services.

In step 513, the RAN may transmit an N1 SM container (e.g., AN-specific resource modification of transport) including updated QoS rules to the UE to support the PDU set handling service. When data transmitted from the UE through the UL is also multiplexed and transmitted to the RAN, the DSCP value used in the UPF, 5QI mapping information, and DSCP marking indication information may be included in the QoS rule and transmitted to the UE.

In step 514, the AMF may receive service related response messages of the UE and the RAN based on the information transmitted in step 512 from the RAN.

In step 515, the AMF may transmit the service related response message received in step 514 to the SMF and transmit an update operation request (e.g., Nsmf_PDUSession_UpdateSMContextt Request) message of session related information.

In step 516, the SMF may transmit an update response (e.g., Nsmf_PDUSession_UpdateSMContext Response) message to session related information to the AMF in response to an update request message to session related information received in step 515.

In step 517, the UPF may perform DSCP marking for each media packet based on DSCP information received from the SMF for the packet for each media type. The UPF may perform DSCP marking within an outer IP header and distinguish packets within the same QoS flow based on the corresponding DSCP value. Through the packet classification process, packets with different media characteristics may have different DSCP values and be transmitted to the RAN through the same QoS flow.

To support PDU set-based sub QoS flow packet handling, the UPF may detect PDU set information in an RTP packet header extension field transmitted from the AS in the DN to the UPF through an N6 section.

In the case of a media type packet without PDU set-based information, the UPF may create basic PDU set information. The UPF requested to perform a mapping operation to a PDU set-based sub QoS flow may transmit the detected or created basic PDU set information to the RAN through the GTP-U header. The PDU set information may include at least one of a PDU set sequence number, an end PDU of the PDU set, a byte size of the PDU set (e.g., PDU set size in bytes), PDU sequence number within a PDU set (e.g., PDU SN within a PDU set), or PDU set importance.

In step 518, the RAN may distinguish packets received from the UPF through the same QoS flow based on the DSCP value in the header of the corresponding packets. Thereafter, the RAN may perform a RAN scheduling operation considering QOS characteristics of packets transferred to the RAN based on the DSCP value and 5QI mapping information transferred from the SMF. The RAN may perform a PDU set-based RAN scheduling operation based on the PDU set QoS profile and PDU set information received from the SMF.

Specifically, in the case of a PDU set-based sub QoS flow, packets within the same sub QoS flow may be additionally classified into PDU sets based on PDU set information. Packets in a classified sub QoS flow may perform scheduling based on the importance of the PDU set.

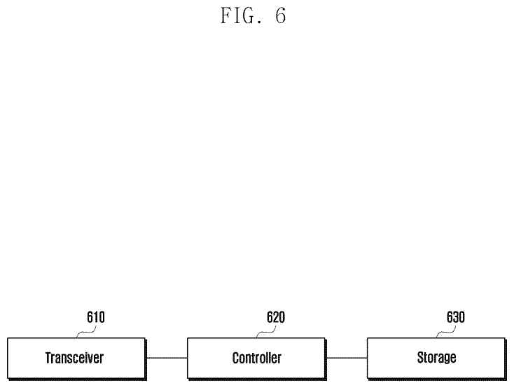

FIG. 6 illustrates a structure of a network entity according to an embodiment.

The network entity of FIG. 6 may indicate one of NFs such as an AMF, SMF, PCF, UDM, UPF, NEF, and AF, as described above.

Referring to FIG. 6, the network entity may include a transceiver 610, a controller 620, and a storage 630. The controller may be defined as a circuit, application-specific integrated circuit, or at least one processor.

The transceiver 610 may transmit and receive signals to and from another network entity. For example, the transceiver 610 may receive a signal from a UE or another network entity.

The controller 620 may control the overall operation of the network entity according to an embodiment herein. The controller 620 may control a signal flow between each block to perform the operations in the message flow diagrams of FIGS. 1 to 5.

The storage 630 may store at least one of information transmitted and received through the transceiver 610 or information created through the controller 620. For example, the storage 630 may store a PDU session ID, data network name (DNN), SM context ID, old single network slice selection assistance information (S-NSSAI), alternative S-NSSAI information, and the like.

Each block of message flow diagrams and combinations of the message flow diagrams may be performed by computer program instructions. Because these computer program instructions may be mounted in a processor of a general purpose computer, special purpose computer, or other programmable data processing equipment, the instructions performed by a processor of a computer or other programmable data processing equipment generate a means that performs functions described in the message flow diagram block(s). Because these computer program instructions may be stored in a computer usable or computer readable memory that may direct a computer or other programmable data processing equipment to implement a function in a particular manner, the instructions stored in the computer usable or computer readable memory may produce a production article containing instruction means for performing the function described in the message flow diagram block(s). Because the computer program instructions may be mounted on a computer or other programmable data processing equipment, a series of operation steps are performed on the computer or other programmable data processing equipment to generate a computer-executed process; thus, instructions for performing the computer or other programmable data processing equipment may provide steps for performing functions described in the message flow diagram block(s).

Each block may represent a portion of a module, a segment, or a code including one or more executable instructions for executing a specified logical function(s). In some alternative implementations, functions recited in the blocks may occur out of order. For example, two blocks illustrated one after another may in fact be performed substantially simultaneously, or the blocks may be sometimes performed in the reverse order according to the corresponding function.

The term unit refers to software or hardware components such as field programmable gate array (FPGA) or application specific integrated circuit (ASIC), and −unit performs certain roles. However, −unit is not limited to software or hardware. −unit may be constituted to reside in an addressable storage medium or may be constituted to reproduce one or more processors. Therefore, as an example, −unit includes components such as software components, object-oriented software components, class components, and task components, processes, functions, properties, procedures, subroutines, segments of program code, drivers, firmware, microcode, circuit, data, databases, data structures, tables, arrays, and variables. Functions provided in the components and −units may be combined into a smaller number of components and −units or may be further separated into additional components and −units. Further, components and −units may be implemented to reproduce one or more CPUs in a device or secure multimedia card. In embodiments, −unit may include one or more processors.

Methods according to the embodiments described in the claims or specifications of the disclosure may be implemented in the form of hardware, software, or a combination of hardware and software.

In the case of being implemented in software, a computer readable storage medium storing one or more programs (software modules) may be provided. One or more programs stored in the computer readable storage medium are configured for execution by one or more processors in an electronic device. The one or more programs may include instructions for causing an electronic device to execute methods according to embodiments described in the claims or specifications of the disclosure.

Such programs (software modules, software) may be stored in a random access memory, a non-volatile memory including a flash memory, a read only memory (ROM), an electrically erasable programmable ROM (EEPROM), a magnetic disc storage device, a compact disc-ROM (CD-ROM), digital versatile discs (DVDs), another form of optical storage device, or a magnetic cassette. Alternatively, the programs may be stored in a memory composed of a combination of some or all thereof. Each constitution memory may be included in the plural.

The program may be stored in an attachable storage device that may access through a communication network such as the Internet, Intranet, local area network (LAN), wide LAN (WLAN), or storage area network (SAN), or a communication network composed of a combination thereof. Such a storage device may access a device implementing an embodiment of the disclosure through an external port. A separate storage device on the communication network may access the device implementing the embodiment of the disclosure.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a policy control function (PCF) entity in a communication system, the method comprising:
receiving, from an application function (AF) entity, an AF session with a required quality of service (QOS), the AF session with the required QoS including QOS requirements for media flows and an additional packet filter;
based on the additional packet filter, determining at least one primary component carrier (PCC) rule for the media flows; and
transmitting, to a session management function (SMF) entity, the at least one PCC rule.

2. The method of claim 1,
wherein the additional packet filter includes at least one of a synchronization source (SSRC), a payload type (PT) or a media identification (MID).

3. The method of claim 1,
wherein QoS flows are transmitted to an user plane function (UPF) entity via N4 rules.

4. The method of claim 1,
wherein the additional packet filter is used to differentiate the media flow among a multiple media flows that share the same legacy packet filter in UE.

5. A method performed by a session management function (SMF) entity in a communication system, the method comprising:
receiving, from a policy control function (PCF) entity, at least one primary component carrier (PCC) rule for media flows; and
transmitting, to a user plane function (UPF) entity, quality of service (QOS) flows and an additional packet filter via an N4 message,
wherein the at least one PCC rule is determined based on the additional packet filter.

6. The method of claim 5,
wherein the additional packet filter includes at least one of a synchronization source (SSRC), a payload type (PT) or a media identification (MID).

7. The method of claim 5,
wherein an application function (AF) session with a required QOS including QoS requirements for the media flows and the additional packet filter is received from the AF entity.

8. The method of claim 5,
wherein the additional packet filter is used to differentiate the media flow among a multiple media flows that share the same legacy packet filter in UE.

9. A policy control function (PCF) entity in a communication system, the PCF entity comprising:
a transceiver; and
a controller coupled with the transceiver, the controller configured to:
receive, from an application function (AF) entity, an AF session with a required quality of service (QOS), the AF session with the required QoS including QoS requirements for media flows and an additional packet filter,
based on the additional packet filter, determine at least one primary component carrier (PCC) rule for the media flows, and
transmit, to a session management function (SMF) entity, the at least one PCC rule.

10. The PCF entity of claim 9,
wherein the additional packet filter includes at least one of a synchronization source (SSRC), a payload type (PT) or a media identification (MID).

11. The PCF entity of claim 9,
wherein QoS flows are transmitted to an user plane function (UPF) entity via N4 rules.

12. The PCF entity of claim 9,
wherein the additional packet filter is used to differentiate the media flow among a multiple media flows that share the same legacy packet filter in UE.

13. A session management function (SMF) entity in a communication system, the SMF entity comprising:
a transceiver; and
a controller coupled with the transceiver, the controller configured to:
receive, from a policy control function (PCF) entity, at least one primary component carrier (PCC) rule for media flows, and
transmit, to a user plane function (UPF) entity, quality of service (QOS) flows and an additional packet filter via an N4 message,
wherein the at least one PCC rule is determined based on the additional packet filter.

14. The SMF entity of claim 13,
wherein the additional packet filter includes at least one of a synchronization source (SSRC), a payload type (PT) or a media identification (MID).

15. The SMF entity of claim 5,
wherein an application function (AF) session with a required QOS including Qos requirements for the media flows and the additional packet filter is received from the AF entity, and
wherein the additional packet filter is used to differentiate the media flow among a multiple media flows that share the same legacy packet filter in UE.
